(19) United States
(12) Patent Application Publication
(10) Pub. No.: US 2012/0150550 A1
(43) Pub. Date: Jun. 14, 2012

(54) Efficiency-of-use techniques

(75) Inventors: Christian L. Belady, Mercer Island, WA (US); Rob Bernard, Redmond, WA (US); Angel Sarmento Calvo, Redmond, WA (US); Larry Cochrane, Redmond, WA (US); Jason Garms, Redmond, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Jennifer Mame Pollard, Redmond, WA (US); John D. Rinaldo, JR., Bellevue, WA (US); Clarence T. Tegreene, Bellevue, WA (US); Rene A. Vega, Scotts Valley, CA (US); Lowell L. Wood, JR., Bellevue, WA (US); Feng Zhao, Redmond, WA (US)

(73) Assignee: Elwha LLC, a limited liability corporation of the State of Delaware

(21) Appl. No.: 13/135,674

(22) Filed: Jul. 12, 2011

Related U.S. Application Data
(63) Continuation-in-part of application No. 12/928,638, filed on Dec. 14, 2010.
Application No. 12/928,638 is a continuation-in-part of application No. 13/135,683, filed on Jul. 12, 2011.

(51) Int. Cl. G06Q 99/00

(52) U.S. Cl. 705/1.1

(57) ABSTRACT

A method for associating an efficiency-of-use-score may include, but is not limited to: associating a physical product with a user account in response to a signal indicating that a user has control of the physical product; generating an efficiency-of-use score based on information associated with how the physical product is used during a period of time that the user has control of the physical product; and associating the efficiency-of-use score with the user account.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/928,638, entitled LIFECYCLE IMPACT INDICATORS, naming Mark Aggar, Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed 14 Dec. 2010, which is currently co-pending or is an application of which a currently co-pending application is entitled to the benefit of the filing date.

For purposes of the USPTO extra-statutory requirements, the present application constitutes a continuation-in-part of the United States patent application having an attorney docket No. 0109-003-015-000000 entitled USER AS PART OF A SUPPLY CHAIN, naming Mark Aggar, Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed contemporaneously herewith under Express Mail No. EM483001152US, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### SUMMARY

A method includes, but is not limited to associating a physical product with a user account in response to a signal indicating that a user has control of the physical product; generating an efficiency-of-use score based on information associated with how the physical product is used during a period of time that the user has control of the physical product; and associating the efficiency-of-use score with the user account. In addition to the foregoing, other system aspects are described in the claims, drawings, and text forming a part of the present disclosure.

In one or more various aspects, related systems include but are not limited to circuitry and/or programming for effecting the herein referenced aspects; the circuitry and/or programming can be virtually any combination of hardware, software, and/or firmware configured to effect the herein-referenced method aspects depending upon the design choices of the system designer.

A computer-readable storage medium product includes, but is not limited to instructions for associating a physical product with a user account in response to a signal indicating that a user has control of the physical product; instructions for generating an efficiency-of-use score based on information associated with how the physical product is used during a period of time that the user has control of the physical product; and instructions for associating the efficiency-of-use score with the user account. In addition to the foregoing, other computer-readable storage medium aspects are described in the claims, drawings, and text forming a part of the present disclosure.

A system includes, but is not limited to circuitry for associating a physical product with a user account in response to a signal indicating that a user has control of the physical product; circuitry for generating an efficiency-of-use score based on information associated with how the physical product is used during a period of time that the user has control of the physical product; and circuitry for associating the efficiency-of-use score with the user account. In addition to the foregoing, other system aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a high-level block diagram of an operational environment.

FIG. 2 shows an exemplary high-level block diagram of an exemplary system.

FIG. 3 shows a high-level block diagram of a product.

FIG. 4 shows a high-level block diagram of a device.

FIG. 5 shows an operational procedure.

FIG. 6A shows an alternative embodiment of the operational procedure of FIG. 5.

FIG. 6B shows an alternative embodiment of the operational procedure of FIG. 5.

FIG. 6C shows an alternative embodiment of the operational procedure of FIG. 5.

FIG. 6D shows an alternative embodiment of the operational procedure of FIG. 5.

FIG. 6E shows an alternative embodiment of the operational procedure of FIG. 5.

FIG. 7 shows an alternative embodiment of the operational procedure of FIG. 6B.

FIG. 8 shows an alternative embodiment of the operational procedure of FIG. 6D.

FIG. 9 shows an alternative embodiment of the operational procedure of FIG. 6E.

FIG. 10 shows an alternative embodiment of the operational procedure of FIG. 6E.

FIG. 11 shows an alternative embodiment of the operational procedure of FIG. 6E.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The consumption of rare materials and the ecological impact caused by human behavior are both becoming serious problems for the Earth. For example, some experts estimate that our use of the ecosystem to obtain food, timber, energy, exceeds the planet's ability to provide. As if the scarcity of resources was not enough of a problem, human behavior is also causing increasing amounts of greenhouse gasses to be emitted into the atmosphere. Certain greenhouse gasses, such as carbon monoxide, sulfur dioxide, chlorofluorocarbons (CFCs) and nitrogen oxides, are generated by manufacturing, using, and disposing of products and the general consensus is that these greenhouse gases cause harm to the environment. For example, according to the 2007 Fourth Assessment Report by the Intergovernmental Panel on Climate Change (IPCC), greenhouse gases have caused the global surface temperature increased 0.74±0.18 C (1.33±0.32 F) during the 20th century. Climate models project that the temperature will increase another 1.1 to 6.4 C (2.0 to 11.5 F) during the 21st century. It is likely that this increase in temperature is a significant problem for living creatures. For example, the living planet index, which is an indicator of the state of global biological diversity, shows that between the period of 1970 and 2003 biodiversity fell 30 percent.

While the demand for products is causing significant damage to the environment, most people are complacent. People generally indicate that they care about the environment; however, people typically do not act in an environment friendly way because they are not aware of how their actions truly affect the environment. On reason for this may be that impact is too abstract to appreciate. For example, a person may recognize that driving a car causes harm to the environment; however, the person may not appreciate how much harm it causes because the person is not penalized nor does the person have to perceive any link between their behavior and the damage caused.

Accordingly, robust methods, systems, and computer program products are provided to, among other things; bring about an operational system wherein users can perceive how consumption behavior affects the environment. In an exemplary embodiment, a user's use of a product can be quantified and a score can be calculated that reflects how efficiently the user is using or has used the product. For example, use data can be mapped to a discrete set of numbers (−99 to 99), or mapped to an abstract scale, e.g., “awful,” “bad,” “neutral,” “good,” and “exceptional” to express how efficiently a product is being used.

In addition to the foregoing, potential-ecological-impact quantifications can be calculated for one or more stages of a product's lifecycle and/or for one or more disposal modes for the product. In at least one example embodiment, a user can perceive the potential-ecological-impact quantifications for a product (or information based at least in part on the quantifications) and understand how much estimated harm the product has caused to the environment (e.g., from the mere fact that it was created) and/or how much harm the product can potentially cause when it is disposed of. The potential-ecological-impact quantifications allow the user to make a determination as to whether he or she wants to use products that are harmful to the environment and/or how to dispose of products he or she owns.

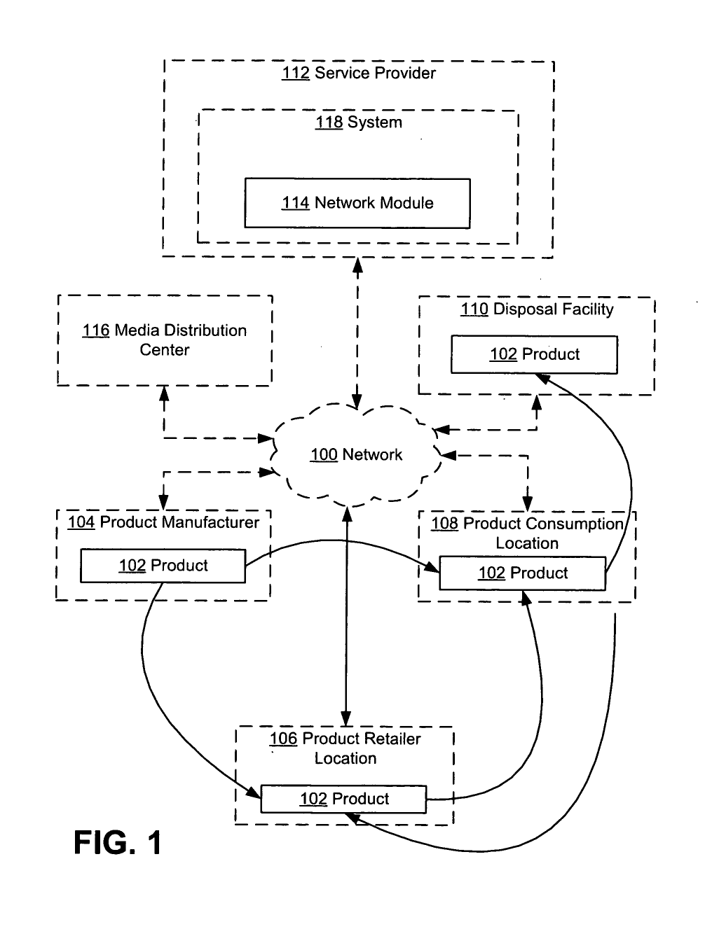

Referring now to FIG. 1, it illustrates a high-level block diagram of an exemplary operational environment that can be used to describe embodiments of the present disclosure. The arrows in dashed lines illustrate how product 102 can move through different locations throughout its life. The block-elements indicated in dashed lines are indicative of the fact that they are considered optional.

As an aside, each location within FIG. 1 can be interconnected via network 100, which may be the Internet. Each location can connect to network 100 using an access method such as, for example, a local area network (LAN), a wireless local area network (WLAN), personal area network (PAN), Worldwide Interoperability for Microwave Access (WiMAX), public switched telephone network (PTSN), general packet radio service (GPRS), cellular networks, and/or other types of wireless or wired networks.

FIG. 1 illustrates various points in the lifecycle of product 102, e.g., an appliance, vehicle, electronic device, food-services item, etc. At some point in time, product 102 can be manufactured by product manufacturer 104. For example, a company can purchase raw materials and/or manufactured materials and create product 102. After product 102 is manufactured, it can be optionally transported to product retailer 106 to be sold to a user (or sold directly to a user) or to a rental company such as a rental car company, an equipment rental company, a leasing center, etc., and transported to product consumption location 108, e.g., a user's home, an office, a city, etc. During the use phase of product 102, one or more efficiency-of-use scores can be computed that reflect whether product 102 is being used or was used efficiently. For example, each time product 102 is used, product 102 can compute an efficiency-of-use score that is based on how product 102 was used as compared to a standard. In an exemplary embodiment, the efficiency-of-use score can be numerical value, and lower scores can reflect more efficient use.

Product 102 can be resold to product retailer 106 (or another product retailer), donated (not shown), or sold to another user (not shown). Eventually, product 102 will be fully consumed, i.e., used up, broken, etc., and can be disposed of. Product 102 can be transported to a disposal facility 110, e.g., landfill, recycling facility, incineration facility, etc., where it can be disposed of.

In an exemplary embodiment, ecological service provider 112 can be used generate potential-ecological impact quantifications and communicate them (or information based on them) to users at different points in the lifecycle of product 102, which is described in more detail in U.S. patent application Ser. No. 12/928,638, entitled LIFECYCLE IMPACT INDICATORS.

In the same, or other embodiments system 118, which can include one or more computer systems having processors, memory, operating system software, network adaptors, etc., can be used to compute efficiency-of-use scores for users based on how they use products. For example, system 118 could be maintained by any number of individuals or organizations that wish to compute how efficiently users use products. In a specific example, system 118 could be maintained by the government. In this exemplary embodiment, the government can monitor how users use products (their own products) and compute efficiency-of-use scores. In another exemplary embodiment, system 118 can be controlled by a Green Organization, e.g., an entity that stands for reducing the impact humans have on the environment. In this example, enrollment with system 118 can be voluntary. In yet another exemplary embodiment, system 118 can be controlled by the owner of product 102, which could be a user or a company. In this case, the owner may require potential users to register with the system in order to use product 102. For example, if product is a rental car system 118 could be controlled by the rental car company. In another specific example, system 118 could be controlled by a neighborhood or condo association that has communal assets that can be used by various members of the association. In this case, each person that lives in the neighborhood or is a member of the condo association may register with system 118 in order to use product 102.

Media distribution center 116 is also illustrated in FIG. 1. Media distribution center 116 can be maintained by the same organization that maintains server 106 or a separate entity. Generally, media distribution center 116 can be configured to receive; store; and/or disseminate information gathered by system 118. For example, media distribution center 116 can be configured to include a web server, email server, short message service (“SMS”) server, television station, etc. In a specific example, media distribution center 116 can receive, store, and/or disseminate information such as efficiency-of-use scores.

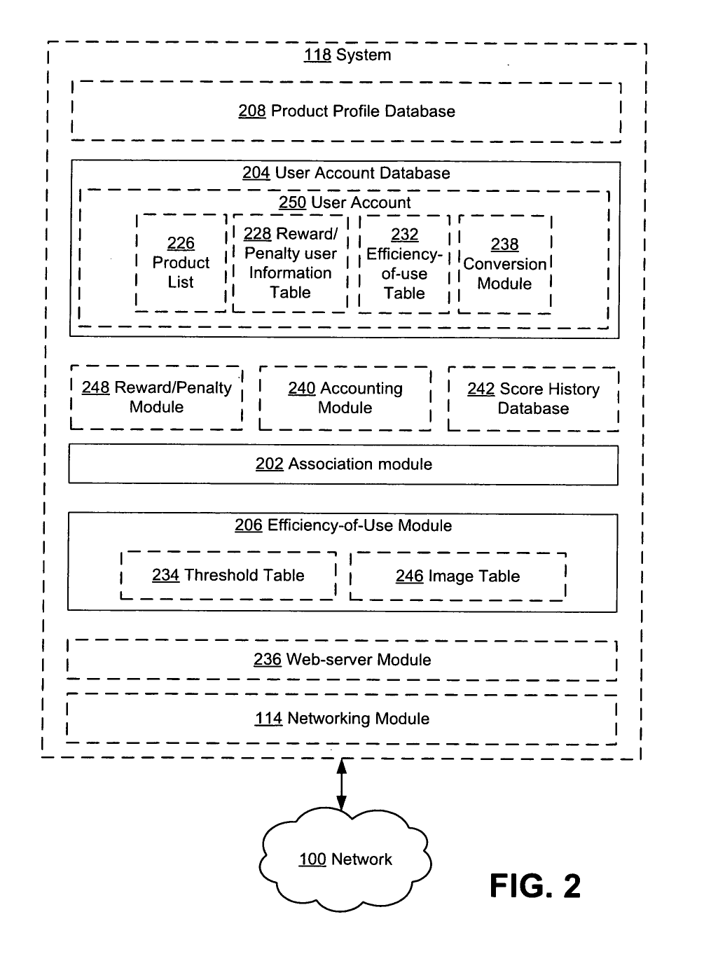

Referring now to FIG. 2, in addition to including any of the subject matter described in U.S. patent application Ser. No. 12/928,638, entitled LIFECYCLE IMPACT INDICATORS, system 118 can also include efficiency-of-use module 206, association module 202, and user account database 204. Association module 202 can be a module of executable instructions that upon execution by a processor can cause the processor to link specific instances of a product to a user account. Briefly, each instance of a product tracked by system 118 can be assigned a unique identifier, e.g., a device-readable indicator or a device-readable indicator plus a unique serial number, and each user that could potentially use the tracked products can be assigned a user account, which can be stored in user account database 204. When a user takes control of a product, e.g., when he or she possesses product, association module 202 can create a relationship between information that identifies the account of a user, e.g., user account 250, and the identifier for product 102. User account 250 is illustrated, which can be associated with user 300 described in more detail in the following paragraphs (while one user account is shown, system 118 can maintain accounts for a plurality of users).

User account database 204 can be maintained by the entity that controls or uses system 118. For example, suppose system 118 is setup by a rental company. In this example, user account database 204 may include user accounts for users that contract with the rental company to rent a product. In another example, suppose system 118 is setup by an energy provider utility. In this example, user account database 204 may include user accounts for users that receive energy from the utility company.

Alternatively, user accounts can be tied into a social network where users can blog, post pictures, send message to each other, etc. In an exemplary embodiment, system 118 can include or be associated with a social networking service maintained by, for example, web-server module 236. Web-server module 236 can be configured to generate one or more web-pages that can be downloaded to computing devices, e.g., table personal-computers, smart phones, etc., that include logic operable to allow users to interact with each other. For example, web-server module 236 can send web-pages to computing devices that allow users to blog, post pictures, etc.

As shown by the figure, each user account, such as user account 250, can optionally include a product list 226, which can contain a listing of products associated with user account 224, i.e., products rented, borrowed, or products that the user owns. Each product in the list can be associated with information that describes its status, e.g., owned, borrowed, or disposed of, the disposal method selected to dispose of the product, how long the product has been associated with the user account, a unique serial number for the product (which can be used to associate specific instances of a product with a specific user), etc.

As described in more detail in U.S. patent application Ser. No. 12/928,638, entitled LIFECYCLE IMPACT INDICATORS, each user account can also be associated with an ecological-impact score, which can be based in part on a user's estimated impact on the environment. In a specific example embodiment, an ecological-impact score can be a running score of the potential-ecological-impact quantifications associated with the user account. For example, suppose a user has an estimated impact score of zero points and purchase a mobile phone with a potential-ecological-impact quantification due to producing the mobile phone of 4 impact points. The user uses the mobile phone for three years and accumulates 5 impact points from charging the mobile phone over the years. After the three years user may throw the mobile phone out in a landfill and cause 3 impact points. The total potential-ecological impact for the mobile phone could be 12 impact points. In this specific example, the ecological-impact score for the user could be 12 impact points.

In another embodiment, the user account can be associated with one or more efficiency-of-use scores that reflect how efficiently the user has used or is using one or more products. In an exemplary embodiment, these scores can be stored in efficiency-of-use table 232. In the same, or another embodiment, a cumulative efficiency-of-use score can be generated and stored in efficiency-of-use table 232. Briefly, the cumulative efficiency-of-use score can be a combination of efficiency-of-use scores for different products. Similar to the potential-ecological-impact quantification described briefly above, an efficiency-of-use score can be a numerical value, e.g., a value from 0 to 10, −100 to 100, etc. In a specific example, higher efficiency-of-use scores could reflect more inefficient use. Thus, a score of 0 in a specific embodiment where the score runs from 0 to 10 would reflect an extremely efficient use whereas a score of 10 would reflect an incredibly inefficient use of a product. In other exemplary embodiments, the efficiency-of-use score could be an abstract indicator such as “bad” or “good.”

As described in more detail in the following paragraphs, one or more efficiency-of-use scores can be calculated and used in a variety of ways. For example, in a specific exemplary embodiment, reward/penalty module 248 can be configured to reward or penalize the user based on his or her score. After a user finishes using a product or while the user is using the product, an efficiency-of-use score can be computed and routed to reward/penalty module 248. Reward/penalty module 248 can process the efficiency-of-use score and determine whether to reward or penalize the user based on the score. If the user is penalized or rewarded, information can be stored in reward/penalty information 228 table. For example, a reward stored in reward/penalty information table 228 could include an icon indicative of a trophy created by an organization committed to acting in an environmentally friendly way. In another embodiment, reward/penalty information table 228 could include a graphic indicative of a coupon, a gift certificate, information indicating free or reduced services given to user 300, etc. Similarly, reward/penalty information table 228 can include penalties associated with user account 250 based on disposal and/or product purchasing behavior. For example, a penalty could be a fee charged to user 300, a trophy with a negative association, etc. In another specific example, efficiency-of-use scores can be used to charge users based on inefficient use of products. For example, accounting module 240 can be configured to charge user accounts fees based on their efficiency-of-use score or scores.

Continuing with the brief overview of certain elements depicted within FIG. 2, efficiency-of-use module 206 can be used to compute efficiency-of-use scores. For example, efficiency-of-use module 206 in embodiments of the present disclosure can be configured to use efficiency information for one or more categories of data to compute an efficiency-of-use score that reflects how efficiently the user is using the product. In a simple example, a product could be a light bulb and efficiency information could be gathered that describes how much energy it uses over a time period, e.g., a day. In this example, the category of data for the light bulb is energy consumed per day. A more complex example may be for an automobile. In this example, data from multiple categories may be used to compute an efficiency-of-use score, e.g., miles per gallon of gasoline achieved data, number of passengers riding in the automobile, miles driven, brake force applied, etc.

In a specific example, each category of data used to compute a score can be associated with a use profile, which can be stored in product profile database 208. Each profile can indicate a standard that reflects efficient use for a category of data. For example, the light bulb referred to above could be associated with a use profile that defines an efficient amount of energy that a light bulb should use over a 24 hour period. In this example, the amount of energy actually used and the amount of energy that defines efficient use can be used to compute the efficiency-of-use score.

As shown by the figure, efficiency-of-use module 206 can be associated with tables of information, which can be used in exemplary embodiments of the present disclosure to configure efficiency-of-use module 206. Briefly, image table 246 can include images of products that can be associated with device-readable indicators. In an exemplary embodiment, products may not include device-readable indicators and efficiency-of-use module 206 can determine indicators from images.

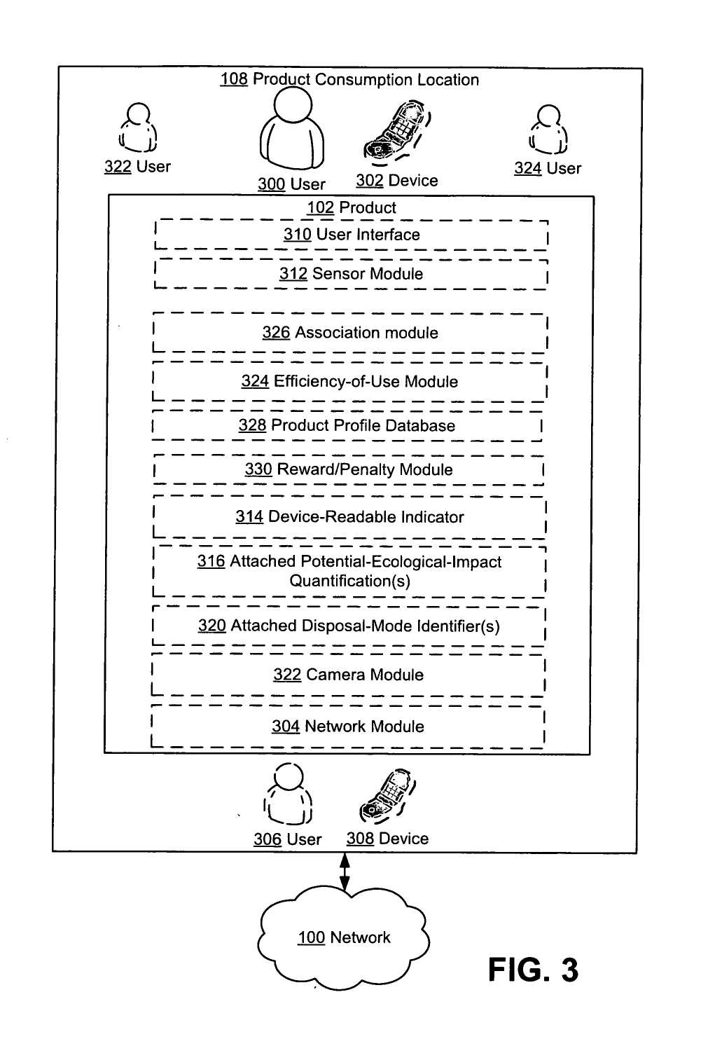

Turning now to FIG. 3, it generally illustrates an exemplary environment, which could be product consumption location 108, e.g., a home, a company, a city, etc. As shown by the figure, in embodiments of the present disclosure, product 102 can be used by one or more users (such as user 300, 322, and 324) during its life. For example, product 102 could be a product that is used by multiple people, e.g., a rental car, a communal washing machine, etc. In this example, user 300 may use product 102 once (or for a short period of time) and then user 322 may use product and so on and so forth. The use of product 102 in this example can be monitored by user 306, who could be an agent of the owner of product 102, e.g., an employee of a rental car company, an employee of a laundromat, etc.

In another embodiment, product 102 may be owned by a user, such as user 300 and used by users 300, 322, and 324. For example, product 102 could be owned by a head of a household and used by other members of the family. In another instance, product 102 could be owned by a corporation and used by employees of the company.

In yet another embodiment, product 102 may be owned by a user such as user 300 and used by user 300 (for years, perhaps). Product 102 can then be sold to another and/or disposed of user sometime later. For example, product 102 could be a TV that is used by user 300 for a couple of years and then sold to user 322. In another instance, product 102 could be a cellular phone that is used until it breaks by user 300, who may then dispose of it.

As shown by the figure, product 102 can optionally include user interface 310, sensor module 312, association module 326, efficiency-of-use module 324, product profile database 328, device-readable indicator 314, one or more potential-ecological-impact quantifications, one or more disposal-mode identifiers, camera module 322, reward/penalty module 324, and/or network module 304. Briefly, user interface 310 can be any type of user interface such as a touch screen or a display and an input device, e.g., a mouse, touch pad, microphone, a keypad, a keyboard, etc. Sensor module 312, which is described in more detail below, can be the hardware and software operable to measure a physical quantity and convert it into an electrical signal.

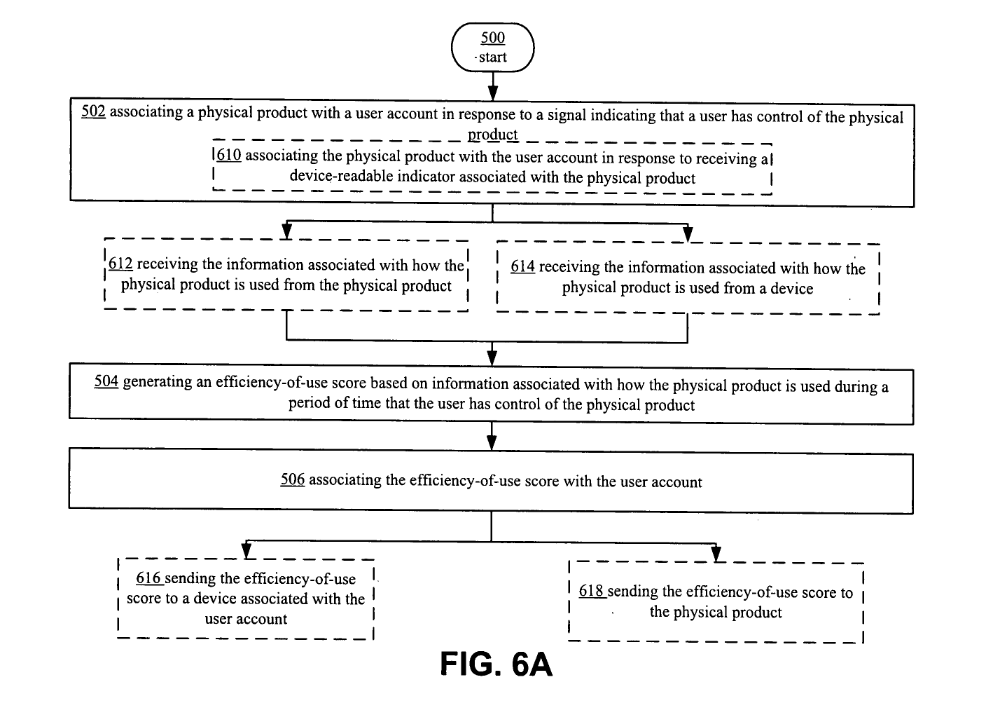

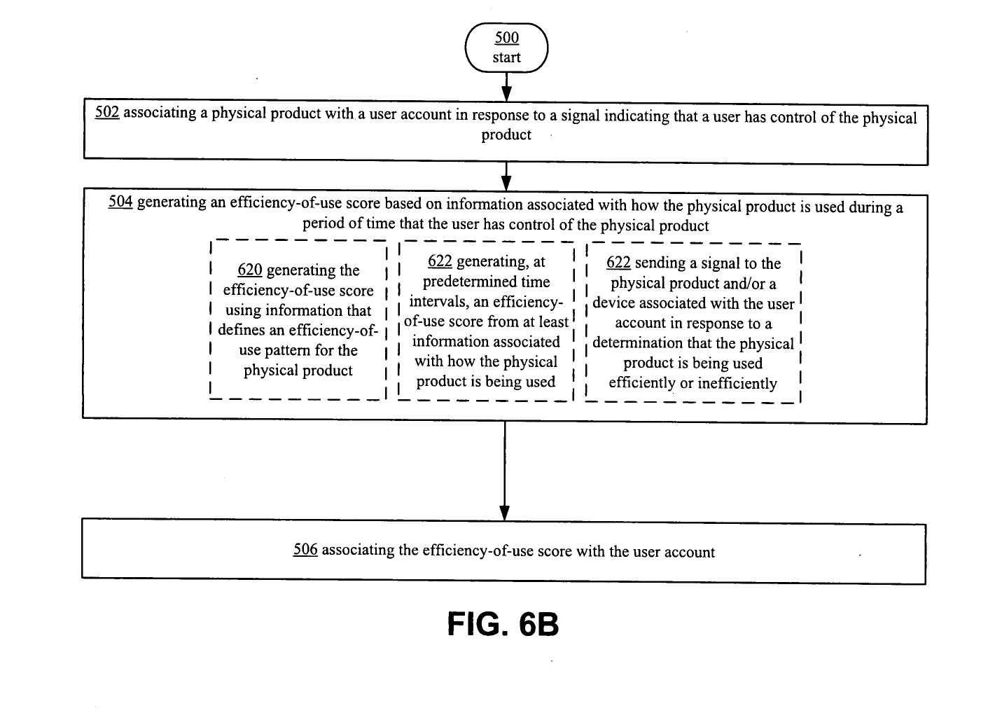

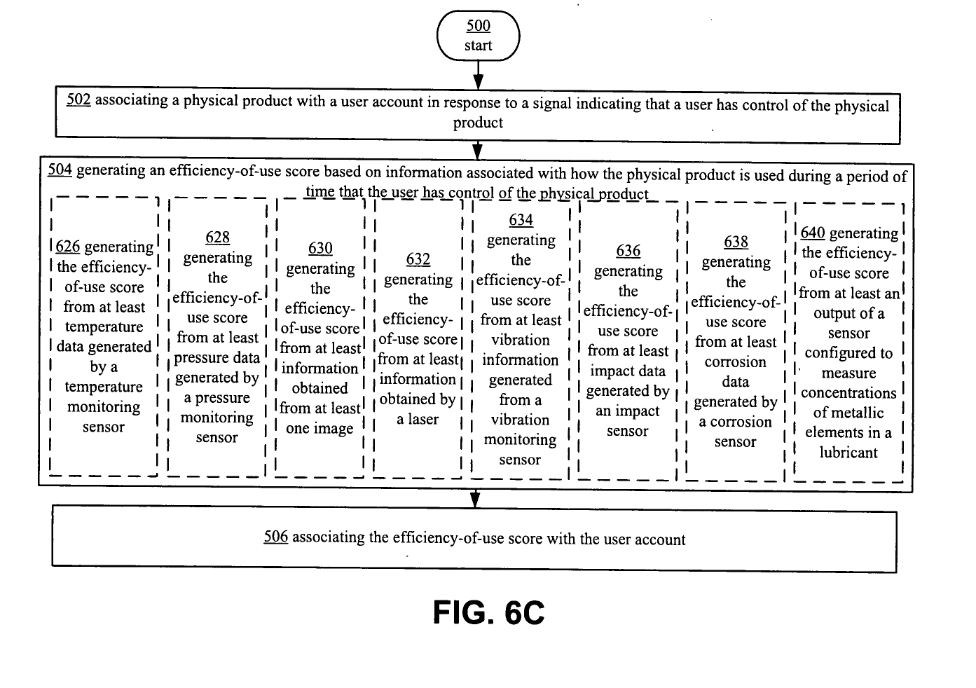

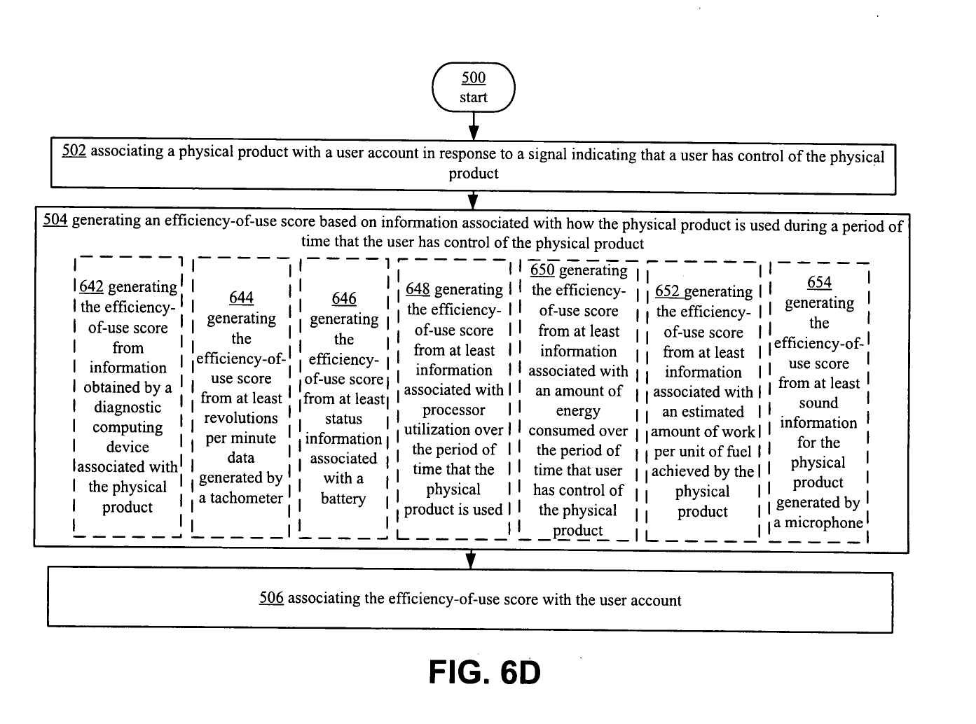

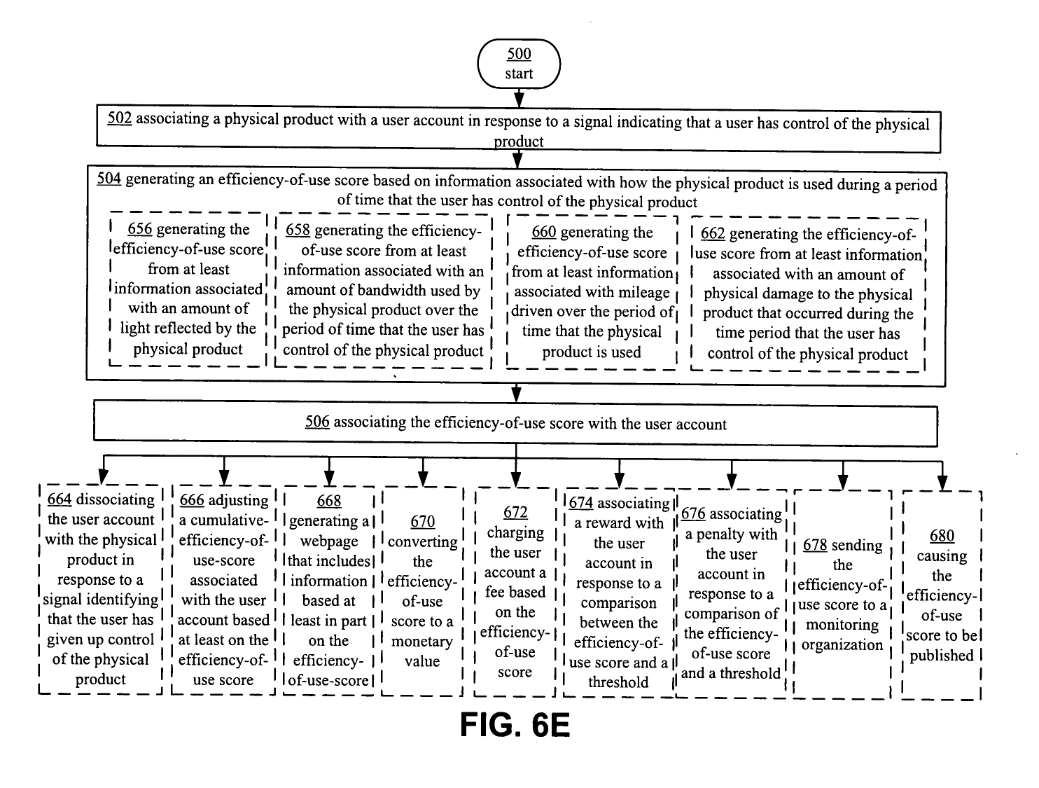

Association module 326, efficiency-of-use module 324, and product profile database 328 can operate similar to association module 202, efficiency-of-use module 206, reward/penalty module 248, and product profile database 208. Consequently, in embodiments of the present disclosure, the functionality described as being associated with association module 202, efficiency-of-use module 206, and product profile database 208 could be integrated within product 102. Thus, in certain embodiments of the present disclosure, efficiency-of-use scores may be computed by the product itself using one or more use profiles that could be locally stored or stored by system 118. Accordingly, while certain operations described with respect to FIG. 6-FIG. 11 are described as being executed by system 118 in specific examples, the disclosure is not limited and each one of the operations described with respect to association module 202, efficiency-of-use module 206, and product profile database 208 could be executed on product 102.

As shown by the figure, product 102 can optionally include device-readable indicator 314, which can be information that can be extracted by device 302 in order to identify product 102. Device-readable indicator 314 could be an alphanumeric value, which can be stored in memory, e.g., RAM or ROM, in a barcode, in an RFID tag, or etched into product 102. In an exemplary embodiment, device-readable indicator 314 can be stored with a unique serial number that also identifies the specific instance of product 102.

In an exemplary embodiment, a potential-ecological-impact quantification can be attached to product 102 in attached potential-ecological-impact quantification(s) 316. In this example, device 302 may be able to obtain one or more potential-ecological-impact quantifications from product 102. Similar to the aforementioned device-readable indicator 314, attached potential-ecological-impact quantification(s) 316 can be stored in memory, a barcode, an RFID tag, and/or etched onto product 102.

In yet another embodiment, product 102 may have one or more attached disposal mode identifiers 320. Disposal mode identifiers can include instructions, e.g., text, audio, images, for disposing of product according to a disposal mode, e.g., incineration, recycling, landfilling, etc.

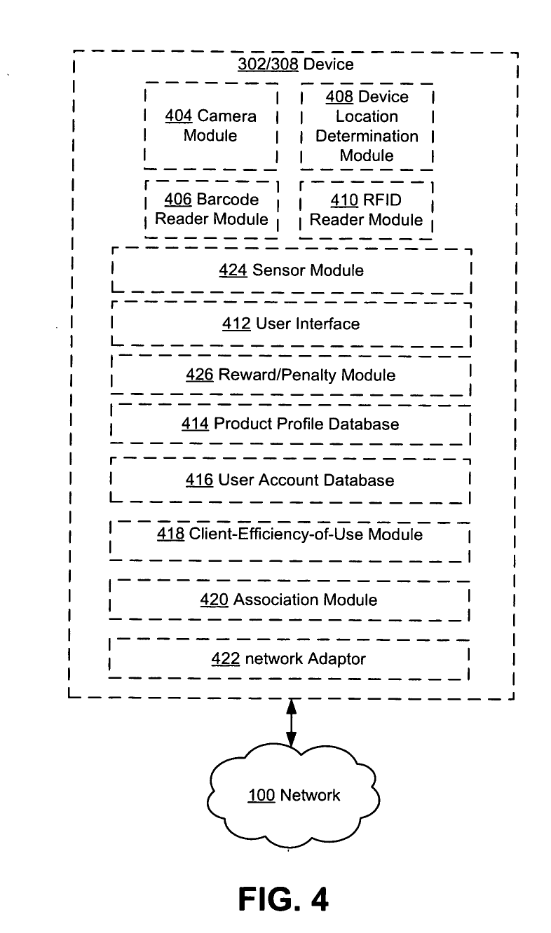

Referring to FIG. 4, it illustrates exemplary modules that can be integrated within device 302. Device 302 may be a computing/communication device including, for example, a cellular phone, a personal digital assistant (PDA), a laptop, a desktop, or other type of computing/communication device. In an exemplary embodiment, device 302 may be a handheld device such as a cellular telephone, a smart phone, a Mobile Internet Device (MID), an Ultra Mobile Personal Computer (UMPC), a convergent device such as a personal digital assistant (PDA), and so forth. For example, device can include memory, e.g., random access memory, ROM, etc., that can contain executable instructions that can be executed by a processor. In addition, device 302 can include various integrated circuits such as GPS radios, network interface adaptors, etc., and the associated firmware that operates such devices. Device 302 can include user interface 310, which could include, but is not limited to, input components implemented by a combination of hardware and software such as a touch user interface, a keypad, a directional pad, a microphone, etc., and output components such as a screen, e.g., an liquid crystal display, a speaker, etc.

Device 302 and/or 308 can optionally include sensor module 424, user interface 412, association module 420, reward/penalty module 426, efficiency-of-use module 418, and product profile database 414 can operate similar to association module 202, efficiency-of-use module 206, reward/penalty module 248, and product profile database 204. Consequently, in embodiments of the present disclosure, the functionality described as being associated with association module 202, efficiency-of-use module 206, and product profile database 208 could be integrated within device 302 and/or 308. Thus, in certain embodiments of the present disclosure, efficiency-of-use scores may be computed by a device external to product 102 using one or more use profiles that could be locally stored or stored by system 118. Accordingly, while certain operations described with respect to FIG. 6-FIG. 11 are described as being executed by system 118 in specific examples, the disclosure is not limited and each one of the operations described with respect to association module 202, efficiency-of-use module 206, and product profile database 208 could be executed on device 302 and/or 308.

Device 302 can obtain device-readable indicator 314 by communicating with product 102 and/or extracting it from product 102 using a barcode reader 406, RFID reader module 410, network adapter 422, or camera 404. In other exemplary embodiments, product 102 may not have an attached device-readable indicator, instead device-readable indicator 314 can be looked up from an image of product 102, audio of a user speaking about product 102, or from user input.

User 300 can optionally use device 302 to obtain ecological information about product 102 such as potential-ecological-impact quantifications. For example, product 102 can include memory, e.g., a barcode, random access memory, read-only memory, etc., which can be used to store information that can be used by device 302 to obtain information based off potential-ecological-impact quantifications and/or the potential-ecological-impact quantifications themselves, among other things.

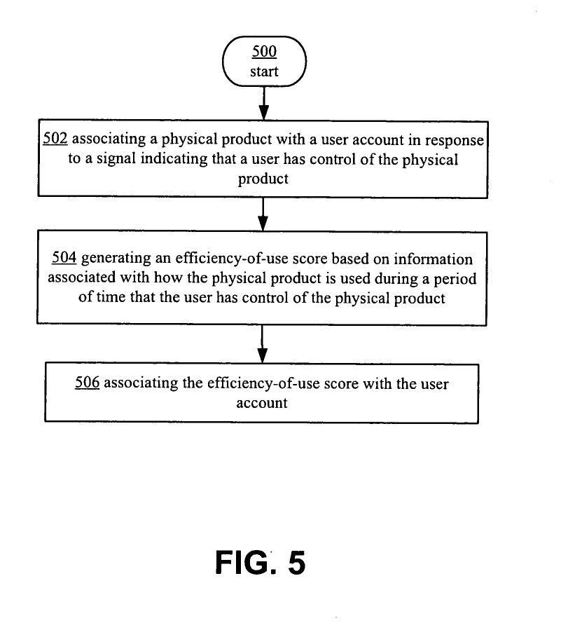

FIG. 5 and the following figures include various examples of operational flows, discussions and explanations may be provided with respect to the above-described exemplary environment of FIGS. 1-4. However, it should be understood that the operational flows may be executed in a number of other environments and contexts, and/or in modified versions of FIGS. 1-4. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

Referring now to FIG. 5, it illustrates an operational procedure for practicing aspects of the present disclosure including operations 500, 502, 504, and 506. Operation 500 begins the operational procedure and operation 502 shows associating a physical product with a user account in response to a signal indicating that a user has control of the physical product. For example, and referring to FIG. 2, association module 202 can be configured to link a user account for user 300, e.g., user account 250, with product 102 and store the information in user account database 204. Association module 202 can be configured to link user account 250 with product 102 in response to receipt of a signal by networking module 114 that indicates that user 300 has control of, i.e., is using, has purchased, etc., product 102. For example, networking module 114 could receive one or more packets of information indicative of an XML package that includes fields that identify product 102, the user account for user 300, and an indication that user 300 has taken control of, i.e., possesses, product 102.

User 300 may be linked to a user account that is stored in user account database 204. In an exemplary embodiment, each user may have their own user account. However, in another embodiment, multiple users may share a user account and/or the user account could be associated with an entity such as a family unit or a corporation. For example, a user account could be for the “Smith family.” In this example, when any member of the Smith family, e.g., Mr. Smith or Ms. Smith, takes control of product 102 a signal can be sent received by association module 202 and information can be stored that indicates that a member of the Smith family has taken control of product 102.

In a specific example, association module 202 can have access to and/or include a table that can store information that links products to users. For example, association module 202 can include a list of products and a list of user accounts. In response to receipt of a signal indicating user 300 has taken control of product 102, association module 202 can be configured to link product 102 with user account 300 by storing information that uniquely identifies product 102 in, for example, product list 226.

Referring briefly to FIG. 3, suppose that product 102 is an automobile and user 300 decides to use it to drive to, for example, the store. In this example, user 300 can take control of the automobile, e.g., by renting it from a company, borrowing it from a friend, reserving it from a service provider, checking it out from a community organization, etc., and a signal can be sent to system 118 that indicates that user 300 has taken control of the automobile. In this specific example, system 118 may be controlled by the rental company.

In another specific example, user 300 may purchase product 102 from, for example, retail location 106 or product manufacturer 104. In this example, an agent of the retail location and/or user 300 could link product 102 to his or her user account, e.g., user account 250. For example, user 300 could input device-readable indicator 314 into device 302 and a signal can be sent to system 118 that indicates that user 300 has taken control of product 102. In this specific example, system 118 may be controlled user 300, the retail location 106, the government, etc.

Referring again briefly to FIG. 5, operation 504 shows generating an efficiency-of-use score based on information associated with how the physical product is used during a period of time that the user has control of the physical product. Turning again back to FIG. 2, an efficiency-of-use score can be generated, e.g., calculated, from information that described how product 102 was used during a period of time that user 300 has or had control of product 102. For example, association module 202 can cause efficiency-of-use module 206 to generate, e.g., compute, an efficiency-of-use score for the use of product 102. For example, networking module 114 of system 118 can receive information that describes how product 102 was used during the period of time that the user had control of it; such as for example, information that describes the status of product 102 or a portion of product 102, information that describes if product 102 was damaged, information that describes how much product 102 depleted, i.e., used-up, etc. This information can be routed to efficiency-of-use module 206, which can use it to compute an efficiency-of-use score, e.g., a numerical value such as 1 to 100 where lower numbers indicate a more efficient use or an abstract score such as “good,” “bad,” “average,” etc., from the information and an efficiency-of-use profile for product 102 stored in product profile database 208. For example, a profile for product 102 can be stored in product profile database 208 that can define the ideal-efficient use of product 102. The information that describes how product 102 was used can be compared to the use profile and the score can be calculated. The use-profile for product 102 could then be updated to reflect its current status in the instance that product 102 is depleted (or partially depleted) during the use.

In a specific example, suppose user 300 purchases product 102, which could be an automobile. In this example, user 300 may control product 102 a significantly long period of time, e.g., 1 year, 5, years, 10 years, etc. In this example, an efficiency-of-use score could be computed each time user 300 drives car, at the end of each day, week, month, etc.

Turning back to FIG. 5, operation 506 shows associating the efficiency-of-use score with the user account. For example, and turning back to FIG. 3, efficiency-of-use module 206 can associate the calculated efficiency-of-use score with user account 250 for stored in user account database 204. For example, efficiency-of-use module 206 can store information indicative of the efficiency-of-use score in a table of information linked to the user account for user 300, i.e., efficiency-of-use table 232, which could be a data structure in memory.

In a specific example, efficiency-of-use module 206 can generate a message that includes information that identifies the product 102, the efficiency-of-use score, and a timestamp. The message can then be sent to user account database 204. User account database 204 can receive the message and determine that it is an efficiency-of-use score user account 250 from, for example, information in the message header, and extract the score, the timestamp, and information that identifies the product 102 and write it into the user account 250.

Turning now to FIG. 6A, it illustrates an alternative embodiment of the operational procedure depicted in FIG. 5 including the additional operations 610-618. Referring to operation 610, it illustrates associating the physical product with the user account in response to receiving a device-readable indicator associated with the physical product. For example, and referring to FIG. 2, a device-readable indicator, which could be a unique alphanumeric value, can be used to identify the product within system 118. In this example, a message could be received by network adapter 114 that includes device-readable indicator 314 for product 102 and a user account identifier for the user account 250. Association module 202 can use device-readable indicator 314 to search through a list of products and link it to user account 250.

Continuing with the description of FIG. 6A, operation 612 shows receiving the information associated with how the physical product was used from the physical product. For example, and referring to FIG. 3, in this example, product 102 can include network adaptor 304 that can be used to communicate information indicating how product 102 was used to service provider 112. Network adaptor 304 can be a wireless radio system or a communication circuit that uses a cable such as a USB or Ethernet cable to connect to a network such as network 100. In a specific example where network adaptor 304 is a wireless radio system, the wireless radio system can be configured to use one of a plurality of wireless protocols to communicate with network 100. For example, the wireless adaptor could be configured to communicate with a Wi-Fi network, a WiMax network, a wireless personal area network, e.g., a network that exchanges signals that are compliant with the Institute of Electrical and Electronics Engineers (IEEE) 802.15 standard, a mobile phone network such as a Code Division Multiple Access (CDMA) or a Global System for Mobile Communications (GSM) based mobile network. In another specific example, the wireless network adaptor could be a point-to-point communication based system. For example, the network adaptor could communicate the information using the Bluetooth® standard, a near-field communication standard, e.g., a European Computer Manufacturers Association (ECMA) standard number 340 or International Organization for Standardization number 1444e, or the Zigbee standard.

Product 102 can be configured to communicate information indicating how product 102 was used to system 118 in real time while the user is using product 102 or after user 300 stops using product 102. For example, suppose that product 102 is an automobile that user 300 rented. When user 300 drops the automobile off at the rental company, the rental car can upload information that describes how the car was used, e.g., status information, to system 118, which could be controlled by the rental car company in this specific example.

Continuing with the description of FIG. 6A, operation 614 shows receiving the information associated with how the physical product was used from a device. Turning to FIG. 3, in an exemplary embodiment a device such as device 302 or a device associated with agent 306 (device 308) can be configured to obtain the information from product 102. In an exemplary embodiment, user 300 and/or user 306 can input information into device 302 and/or 308. In another example embodiment, device 302 and/or 308 can extract the information from product 102. For example, product 102 can include sensor module 312, which could include one or more sensors that monitor one or more physical quantities and converts it into an electrical signal. The sensor module 312 can then use networking module 304 to communicate the information to device 302 and/or 308.

In a specific example, suppose that a rental car company implements aspects of the present disclosure and maintains system 118. In this example, suppose user 300 creates an account when he or she rents an automobile. Eventually user 300 can return the automobile and user 306, e.g., an agent of the rental car company, can use device 308 to extract information from sensor module 312, e.g., a computer that monitors the status of the automobile. Device 308 can transmit the information to the rental car company's system, e.g., an implementation of system 118, and efficiency-of-use module 206 can compute a score for user 300.

Turning briefly back to FIG. 6A, also illustrated is operation 616, which shows sending the efficiency-of-use score to a device associated with the user account. For example, and referring briefly to FIGS. 2 and 3, an efficiency-of-use score can be determined by efficiency-of-use module 206 and routed to networking module 114. Networking module 114 can send one or more packets of information indicative of the efficiency-of-use score to device 302 of FIG. 3 via network 100, e.g., the Internet. Turning briefly to FIG. 4, network adaptor 422 of device 302, e.g., a wireless radio, can receive the one or more packets of information indicative of the efficiency-of-use score and cause the efficiency-of-use score to be rendered on user interface 412. For example, a graphics display subsystem of user interface 412 can receive the efficiency-of-use score and draw an image on a display of device 302.

Suppose that user 300 was using product 102, e.g., an automobile, and checked the automobile back into a communal product repository for a condo association. Efficiency-of-use module 206 can lookup an identifier for device 302, e.g., an email, phone number, IP address, etc., associated with device 302 in user account database 204; generate a message, e.g., an email, text message, data package, etc., and send the message to that identifier. In this specific example, suppose the user account database 204 also includes an IP address associated with device 302. In this example, efficiency-of-use module 206 could be configured to generate a message conforming to a protocol and send it to the IP address associated with device 302. In this specific example, network adaptor 422 of device 302 can receive the message and determine that it is for a client efficiency-of-use module 418 and route it accordingly. Client efficiency-of-use module 418 can receive the message and extract the efficiency-of-use score from it. Client efficiency-of-use module 418 can then access an application program interface of user interface 412 and generate an image that depicts the efficiency-of-use score. In this regard, user 300 can receive his or her efficiency-of-use score after he or she uses the automobile and/or while he or she is using the automobile.

Returning to FIG. 6A, operation 618 shows sending the efficiency-of-use score to the physical product. For example, and referring briefly to FIGS. 2 and 3, an efficiency-of-use score can be determined by efficiency-of-use module 206 and routed to networking module 114. Networking module 114 can send one or more packets of information indicative of the efficiency-of-use score to product 102 of FIG. 3 via network 100, e.g., the Internet. Network adaptor 304 of product 102, e.g., an Ethernet adaptor, can receive the one or more packets of information indicative of the efficiency-of-use score and cause the efficiency-of-use score to be rendered on user interface 310. For example, a graphics display subsystem of user interface 310 can receive the efficiency-of-use score and draw an image on a display. In a specific example, suppose product 102 is a blender located in a common area of an apartment building. In this example, user 300 could use the blender and then a display integrated within the blender can display an efficiency-of-use score.

Turning now to FIG. 6B, which continues the description of the additional operations that can be executed in conjunction with those illustrated in FIG. 5, operation 620 shows generating the efficiency-of-use score from at least information that defines an efficiency-of-use pattern for the physical product. Referring to FIG. 2, in this exemplary embodiment, efficiency-of-use module 206 can be configured to calculate efficiency-of-use scores from data from one or more categories of data. For example, a category of data for an automobile may be miles driven or average miles per gallon of gasoline. A category used to compute how efficiently a mobile device was used could be energy used over a time period. This data can be compared to one or more use-profiles and a sub-score, e.g., a percentage, for the category can be calculated. In this example, the percentage could reflect how closely the user was to the ideal-efficient use. The sub-score, which reflects how closely the use was to an optimal use in a select category, can be weighted; combined with zero or more other sub-scores; and used to compute an efficiency-of-use score. In a specific example, the sub-scores for each category can be weighted and summed. This value can then be divided by the sum of the weights and normalized to obtain an efficiency-of-use score. One of skill in the art can appreciate that the disclosure is not limited to using this specific type of equation to calculate efficiency-of-use scores and any equation can be used.

Suppose that product 102 is a washing machine located in a self-service laundry facility called a laundromat. In this example, a use-profile for the washing machine could include an efficiency metric that indicates the efficient amount of clothing that should be washed in a single cycle in terms of weight. In this example, suppose the information that describes how the washing machine was used includes the weight of the clothing washed by user 300 in a wash cycle. In this example, efficiency-of-use module 206 could compare the weight of the clothing washed by user to a use-profile for the washing machine and calculate the percentage. The percentage could then be normalized and mapped to a numerical score or an abstract score. For example, the use-profile may indicate that the most efficient weight per wash cycle is 10 pounds and the weight of the clothing washed by user 300 was 8 pounds. Efficiency-of-use module 206 can calculate the percentage and determine that the wash was 20% inefficient (8/10=0.2). Efficiency-of-use module 206 can then map the calculated efficiency percentage to a score, e.g., a score of 1 in the instance that the scale is 0-5, i.e., 0.2*100/20=1 where 20 is a normalizing value.

In another specific example, suppose that the use-profile for the washing machine includes multiple efficiency metrics, e.g., weight and water used. In this example, the use-profile could indicate the efficient amount of weight and water used to wash clothing. In this example, suppose the information that describes how the washing machine was used indicates that 8 pounds of clothing were washed in 21 gallons of water. In this example, the use-profile may indicate that the most efficient weight per wash cycle is 10 pounds and the most efficient amount of water to use per wash is 15 gallons of water. Efficiency-of-use module 206 can calculate the difference and determine that the weight was 20% inefficient and amount of water used was 40% inefficient. Efficiency-of-use module 206 can then apply weights to the two scores, and calculate a score that takes both variables into consideration. For example, if both the weight category and the water category had the same weights (which are 1 in this example), then a score could be calculated to be 1.5, i.e., (((0.2*100)+(0.4*100))/(1+1))/20=1.5, where 20 is a normalizing value.

Turning now to FIG. 6B, operation 622 shows generating, at predetermined time intervals, an efficiency-of-use score from at least information associated with how the physical product is being used. For example, and referring briefly to FIG. 2, efficiency-of-use module 206 can be configured to generate incremental scores over a period of time that user 300 has control of, i.e., possesses, product 102. For example, information that describes how product 102 is being used by user 300 such as for example, information that describes the status of product 102 or a portion of product 102, can received by networking module 114. The information that describes the status of product 102 can be routed to efficiency-of-use module 206, which can calculate an efficiency-of-use score at predetermined intervals, e.g., once a day, a hour, a minute, a second, etc. Efficiency-of-use module 206 can then be configured to add the efficiency-of-use scores to efficiency-of-use table 232. Thus, in this example, efficiency-of-use scores can be computed for a product that is owned for a long period of time by user 300, e.g., a refrigerator, an oven, a dish washing machine, a lawn mower, a DVD player, a mobile device, etc.

Continuing with the description of FIG. 6B, operation 624 shows sending a signal to the physical product and/or a device associated with the user account in response to a determination that the physical product is being used efficiently or inefficiently. Turning briefly to FIG. 2, in an exemplary embodiment, efficiency-of-use module 206 can include (or have access to) threshold table 234, which can include information that indicates when a product, such as product 102, is being used inefficiently or efficiently. In a specific example, threshold table 234 can include a quantification, e.g., a value such as 2, associated with a category of data, e.g., number of passengers simultaneously using a car, associated with physical product 102, e.g., the car. In this example, efficiency-of-use module 206 could receive information that indicates that only one person, i.e., user 300, is using product 102, and compare this value to the value stored in threshold table 234. In this specific example, efficiency-of-use module 206 could be configured to determine that user 300 is using product 102 inefficiently. Alternatively, efficiency-of-use module 206 can determine that product 102 is being used efficiently in the instance that the data associated with a category matches and/or is within a predetermined range of the value stored in threshold table 234.

In response to the determination, efficiency-of-use module 206 can generate a signal, e.g., a message indicating that user 300 is using product 102 inefficiently or efficiently, and cause the message to be sent to product 102 and/or a device associated with user 300, e.g., device 302. The message can be sent by networking module 114 in one or more packets of information to device 302 and/or product 102. In an exemplary embodiment, in response to receipt of the signal information could be displayed that indicates that product 102 is being used inefficiently or efficiently. For example, an indicator on physical product 102 can turn a color, e.g., red, to signify to user 300 and/or the outside world that product 102 is being used inefficiently or green to signify to user 300 and/or the outside world that product 102 is being used efficiently. For example, suppose product 102 is an automobile that includes a display, e.g., an LCD screen, plasma screen, etc., attached to the back above the license plate. In this example, when the automobile is being used inefficiently and a signal is received from system 118, the display could change to red or some other color to signify that it is being used inefficiently.

In another specific example, user interface 310 of product 102 and/or user interface 412 of device 302 could display information that indicates that product 102 is being used inefficiently or efficiently. For example, text and/or a graphic could be rendered on the user interface that describes that product 102 is being used inefficiently efficiently and/or the reason(s) for why the determination was made.

Turning now to FIG. 6C, which continues the description of the additional operations that can be executed in conjunction with those illustrated in FIG. 5, operation 626, it shows generating the efficiency-of-use score from at least temperature data generated by a temperature monitoring sensor. Turning briefly to FIG. 3 and/or FIG. 4, sensor module 312 or 424 in can be a temperature monitoring sensor that can be attached to product 102, a sub-component of product 102, and/or a device, e.g., device 302 or 308. In this specific example, temperature data can be gathered by the temperature monitoring sensor at least during the period of time that product 102 is controlled by user 300, i.e., during the time product 102 is associated with the user account for user 300 (which could be an hour, a day, a year, etc). In this example, the temperature monitoring sensor can generate temperature data and encode it within a message that could include a field that identifies product 102; the type of data stored in the package (temperature data); and a temperature value. This message can be sent, e.g., via networking module 304 attached to product 102 or an adaptor located elsewhere, to networking module 114 of system 118. The message including the temperature data can be routed to efficiency-of-use module 206, which can extract the temperature data and use it by itself or along with data from other categories to compute an efficiency-of-use score.

In a specific example, suppose product 102 is a computing device such as a laptop computer system. In this example, suppose a user uses the laptop computer in a way that causes it to generate large amounts of heat, e.g., the user overclocks the processor or leaves the laptop on instead of in sleep mode. In another specific example, suppose product 102 is an automobile. In this example, the temperature monitoring sensor could be used to determine the operating temperature of the car. In another example, product 102 could be a battery, e.g., a lithium-ion battery. Lithium-ion batteries have a lifespan that is affected by the temperature at which the battery is stored and the state-of-charge of the battery when it is stored. In this example, the temperature monitoring sensor can generate a signal that indicates the temperature of the battery and a message including the temperature can be sent to system 118 and used to generate an efficiency-of-use score.

Turning now to operation 628 of FIG. 6C, it illustrates generating the efficiency-of-use score from at least pressure data generated by a pressure monitoring sensor. Referring now to FIG. 3 and/or FIG. 4, sensor module 312 or 424 in can be a pressure monitoring sensor that can be attached to product 102, a sub-component of product 102, and/or a device, e.g., device 302 or 308. In this specific example, pressure data can be gathered by the pressure monitoring sensor at least during the period of time that product 102 is controlled by user 300. In this example, the pressure monitoring sensor can generate pressure data and encode it within a message that could include a field that identifies user account 250; the type of data stored in the package (pressure data); and a pressure value. This message can be sent to networking module 114 of system 118. The message including the pressure data can be routed to efficiency-of-use module 206, which can extract the pressure data and use it to compute an efficiency-of-use score.

In a specific example, suppose the pressure monitoring sensor is a MEMS sensor that can be placed within a tire, a liquid, e.g., water, oil, etc. In this example, as product 102 is being used, pressure data can be captured and routed to efficiency-of-use module 206. Efficiency-of-use module 206 can then use the data to computer an efficiency-of-use score. For example, suppose product 102 is a tire of a rental car. In this example, the pressure data could indicate that the tire and by extension the car is being stressed, which in turn could cause unreasonable wear-and-tear on one or more components of the vehicle.

Referring briefly back to FIG. 6C, operation 630 shows generating the efficiency-of-use score from at least information obtained from at least one image. Referring again to FIG. 2, in an exemplary embodiment, efficiency-of-use module 206 can determine an efficiency-of-use score from at least one image of product 102. For example, and referring to FIG. 4, suppose device 302 and/or device 308 includes camera module 404, which could include a video camera and/or a still image camera. In this example, one or more images, e.g., a video and/or a group of one or more pictures, can be generated by camera module 404 and sent to system 118. In a specific example, suppose a user such as user 306, who could be the owner of product 102 or an agent of the owner, could use device 308 to generate images of product 102, e.g., images of damage to product 102 and/or a subcomponent of product 102, after user 300 returns it. Returning to FIG. 2, the one or more images can be transferred to system 118 and analyzed by efficiency-of-use module 206, e.g., by comparing the images to images stored in image table 246, and a difference between the images captured and previously stored images can be determined. The difference can be used by efficiency-of-use module 206 to calculate a score. Alternatively, each image showing, for example, damage to product 102 can be noted and the number of images showing damage can be counted. The count could then be used as a factor in determining an efficiency-of-use score.

In another specific example, product 102 can include camera module 322, which can be configured to capture images of one or more subcomponents of product 102. For example, product 102 could be a chainsaw and the camera module can be configured to capture images of the blades in the chainsaw before and after user 300 uses product 102. In this example, the difference between how one or more blades appear in the images can be computed by efficiency-of-use module 206 and quantified. The quantification can then be used by efficiency-of-use module 206 to calculate an efficiency-of-use score. For example, suppose user 300 uses the chainsaw to cut down a tree and in the process damages one or more teeth of the chainsaw. In this example, efficiency-of-use module 206 can determine from one or more images that one or more of the teeth were damaged and compute an efficiency-of-use score that reflects that the chainsaw was used inefficiently, i.e., the user caused great wear-and-tear on product 102.

In another specific example, suppose product 102 is a vehicle that includes camera module 322 configured to take images of a tire. In this example, the difference between how the tread of the tire appears in before and after images can be computed by efficiency-of-use module 206 and quantified. The quantification can then be used by efficiency-of-use module 206 to calculate an efficiency-of-use score. For example, suppose user 300 slams on the breaks of the vehicle and causes large portions of the tire to wear off. In this example, efficiency-of-use module 206 can determine an efficiency-of-use score that reflects that the vehicle was used inefficiently.

Turning briefly back to FIG. 6C, operation 632 shows generating the efficiency-of-use score from at least information obtained by a laser. Referring now to FIG. 3 and/or FIG. 4, sensor module 312 or 424 in can be a laser module that can be attached to product 102, a sub-component of product 102, and/or a device, e.g., device 302 or 308. In this specific example, rotational information, e.g., from a ring laser gyroscope, dimensional measurements, e.g., distance, thickness, etc. can be gathered by the laser sensor at least during the period of time that product 102 is controlled by user 300, i.e., during the time product 102 is associated with the user account for user 300. In this example, the laser module can generate data and encode it within a message that could include a field that identifies product 102 and user account 250; the type of data stored in the message; and the data. This message can be sent to networking module 114 of system 118. The message can be routed to efficiency-of-use module 206, which can extract the data and use it to compute an efficiency-of-use score.

In a specific example, suppose product 102 is a set of breaks within an automobile. In this example, suppose the laser module is installed within the automobile so that it can reflect a laser beam off the break pads and determine thickness information. After a user uses the automobile, the laser module can again gather information that indicates how thick the break pads are and send the information to system 118, which could be located at a rental company, or store the information for extraction by an agent of the rental car company. The information can be routed to the efficiency-of-use module 206 and used to calculate an efficiency-of-use score that takes into account the amount of wear that was placed on the breaks relative to an amount that constitutes an efficient use of the breaks.

Turning briefly again to FIG. 6C, operation 634 shows generating the efficiency-of-use score from at least vibration information generated from a vibration monitoring sensor. Again turning to FIG. 3 or 4, sensor module 312 associated with product 102 and/or sensor module 424 of device 302 or 308 can be a vibration monitoring sensor, e.g., a piezoelectric sensor. In this exemplary embodiment, the vibration monitoring sensor could be installed within a machine such a skid loader, e.g., a Bobcat®, to monitor vibration associated with one or more internal mechanical parts. As product 102 is used, the vibration monitoring sensor can generate vibration information and either send the information to system 118 or store it for later extraction. Efficiency-of-use module 206 can receive the vibration data and compare it to a profile for product 102 stored in product profile database 208. Efficiency-of-use module 206 can then use the difference to compute an efficiency-of-use score for the use of product 102 by user 300.

For example, internal components vibrate differently when under different amounts of stress. For example, a refrigerator's internal cooling machinery may vibrate when cooling the refrigerator. A situation where the internal cooling machinery is operating for long periods of time can be indicative of inefficient use of the refrigerator, e.g., the temperature is set too low. In another example, the vibration monitoring sensor could be placed relative to an engine in a vehicle, e.g., automobile, boat, etc. In this example, a vibration profile could be created for the engine that reflects efficient operation of the engine. As the stress on the engine changes it may vibrate differently and the vibration sensor can generate an electrical signal indicative of how the engine is vibrating and send it to efficiency-of-use module 206, which can use the difference between the profile and how the engine is or was vibrating to calculate an efficiency-of-use score.

Turning now to FIG. 6C, operation 636 shows generating the efficiency-of-use score from at least impact data generated by an impact sensor. For example, and again turning to FIG. 3 or 4, sensor module 312 associated with product 102 and/or sensor module 424 of device 302 or 308 can be an impact sensor module, e.g., a piezoelectric sensor. In this exemplary embodiment, the impact monitoring sensor could be installed within a device such as a laptop to monitor whether the laptop is dropped or deformed by an outside force. As product 102 is associated with user 300, the impact monitoring sensor can generate impact information either record it (within memory) or send it to system 118. Efficiency-of-use module 206 can receive the impact data and compare it to a profile for product 102 stored in product profile database 208. Efficiency-of-use module 206 can compute an efficiency-of-use score for the use of product 102 by user 300. In a specific example, if the user drops the laptop or smashes it by placing heavy books on it, the impact sensor module can generate an electrical signal indicative of the impact and the electrical signal can be communicated to efficiency-of-use module 206. Efficiency-of-use module 206 can then use this information to compute an efficiency-of-use score that reflects that the laptop was inefficiently used, e.g., it was smashed, dropped, etc.

Referring again to FIG. 6C, operation 638 shows generating the efficiency-of-use score from at least corrosion data generated by a corrosion sensor. For example, and again turning to FIG. 3 or 4, sensor module 312 associated with product 102 and/or sensor module 424 of device 302 or 308 can be an corrosion sensor module that measures the extent of rust and corrosion on product 102. In this exemplary embodiment, the corrosion sensor could be installed within a device that is exposed to weather, e.g., a lawn mower, an vehicle, a grill, i.e., a device used to cook food, etc. While product 102 is associated with user 300, the corrosion sensor module can generate an electrical signal based on the amount of corrosion detected on product 102 and either record it (within memory) or send it to system 118. Efficiency-of-use module 206 can receive the electrical signal data and compare it to a profile for product 102 stored in product profile database 208. Efficiency-of-use module 206 can then compute an efficiency-of-use score for the use of product 102.

In a specific example, suppose user 300 borrows a lawn mower and then leaves it outside overnight prior to returning it to his neighborhood association. In this example, suppose an agent of the neighborhood association checks the lawn mower back in and uses device 308, which could include a corrosion sensor, to scan the lawn mower. In this example, the agent could receive a signal indicative of how much corrosion occurred and use this along with a corrosion profile for the lawn mower to compute an efficiency-of-use score that takes corrosion that was caused by the inefficient use of product 102 in account.

Turning briefly back to FIG. 6C, operation 640 shows generating the efficiency-of-use score from at least an output of a sensor configured to measure concentrations of metallic elements in a lubricant. For example, and again turning to FIG. 3 or 4, sensor module 312 associated with product 102 and/or sensor module 424 of device 302 or 308 can be an sensor module that measures the amount of metallic elements that are present within a lubricant 102. An impotent function of lubricant is to improve or enhance the friction and wear characteristics of surfaces in relative motion. For example, internal combustion engines require chemically formulated lubricants to provide operational efficiency and durability. The use of lubricants in this application, not only reduces friction and wear, but controls the accumulation of unwanted deposits derived from the combustion process, as well as dissipating heat. In this exemplary embodiment, the sensor could be installed within tank that contains a lubricant, e.g., motor oil, and can be configured to monitor the amount of waste materials, e.g., metallic elements, that accumulate within the lubricant. While product 102 is associated with user 300, the sensor module can generate an electrical signal based on the amount of waste materials detected in the lubricant and either record it (within memory) or send it to system 118. Efficiency-of-use module 206 can receive the electrical signal data and compute an efficiency-of-use score for the use of product 102 that takes at least this factor into account.

In a specific example, suppose user 300 owns an automobile, but fails to regularly change the oil. In this example, suppose the automobile includes a sensor to monitor one or more lubricants and generates an electrical signal indicating that the oil is polluted, which causes the automobile to operate inefficiently. In this example, the sensor, can generate a value based on the pollution within the lubricant and send a signal, which can eventually be routed to efficiency-of-use module 206. Efficiency-of-use module 206 can compute an efficiency-of-use score that is based at least in part on the inefficient use of the automobile.

Turning now to FIG. 6D, which continues the description of the additional operations that can be executed in conjunction with those illustrated in FIG. 5, operation 642 shows generating the efficiency-of-use score from information obtained by a diagnostic computing device associated with the physical product. For example, and again turning to FIG. 3 or 4, sensor module 312 associated with product 102 and/or sensor module 424 of device 302 and/or 308 can be an sensor module can include a diagnostic computing device, e.g., a microprocessor configured to monitor one or more operating parameters of product 102. For example, product 102 which could be an automobile, computer system, i.e., a web-server, a personal laptop computer, a videogame console, etc., can include a microprocessor configured to receive input from various sensors and control product 102. In a specific example, product 102 can be an automobile and the diagnostic computing device could be the car-computer. In this example, the car-computer could control the air/fuel mixture, manage emissions and fuel economy; temperature of the coolant; deployment of the airbag, whether the anti-lock brakes are deployed, etc. Similarly, in a web-server the diagnostic computing device could be a module of executable code that monitors the speed the CPU fans are operating at, the temperature of the CPU, and operating system characteristics such as the amount of available random access memory, the number of page faults, etc. The diagnostic computing device could also be an external computing device that can be connected (wirelessly or physically) to one or more components of product 102. In a specific example, diagnostic computing device could be a handheld battery testing device that can check the status of an automobile's battery and electrical system. Diagnostic computer device can then gather information about product 102, i.e., about one or more components of product 102.

In this exemplary embodiment, the data generated by the diagnostic computing device can be recorded or sent it to system 118. Efficiency-of-use module 206 can receive the electrical signal data and compute an efficiency-of-use score for the use of product 102 that takes at least some of this information into account.

Turning briefly back to FIG. 6D, operation 644 shows generating the efficiency-of-use score from at least revolutions per minute data generated by a tachometer. For example, and again turning to FIG. 3 or 4, sensor module 312 associated with product 102 and/or sensor module 424 of device 302 and/or 308 can be an sensor module that measures revolutions per minute data of, for example, an engine of an automobile. In this example, a sensor module operatively coupled to the engine can generate an electrical signal indicative of the rate of revolution of the engine and either record it (within memory, e.g., RAM, ROM, etc.) or send it to system 118. Efficiency-of-use module 206 can receive the electrical signal data and compute an efficiency-of-use score for the use of product 102 that takes at least this factor into account. For example, the average revolutions per minute can indicate how hard the engine was working over a period of time, e.g., a minute, an hour, or during a trip, i.e., from when the car is turned on until it is turned off. This information in turn can be used to calculate how efficiently the automobile was used. For example, an automobile associated with high RPM data could be indicative of inefficient use.

Again turning to FIG. 6D, operation 646 shows generating the efficiency-of-use score from at least status information associated with a battery. For example, and again turning to FIG. 3 or 4, sensor module 312 associated with product 102 and/or sensor module 424 of device 302 and/or 308 can be an sensor module that measures battery data, e.g., the number of times that the battery was discharged, the percentage of battery charge that was discharged prior to it being recharged, operating temperature of the battery, etc. In a specific example, the battery could be a lithium-ion battery used to supply energy to a laptop, hybrid automobile, or a mobile device. The life of a battery is determined by the number of cycles it has to perform and the depth of the discharge. For example, a lithium-ion battery provides 300-500 discharge/charge cycles. In addition, the life of the battery can be affected by discharging all or a portion of the battery prior to recharging it. For example, it is preferable to partially discharge the battery than to fully discharge it. In general, the optimum life to utility ratio may occur if the battery is not discharged lower than 40˜50 percent for certain types of batteries, e.g., certain types of lithium-ion battery.

In an exemplary embodiment where status information of the battery is used to calculate an efficiency-of-use score, the sensor can be operatively coupled to the battery and can track the number of charge cycles and/or the amount of charge that is discharged and either record it (within memory, e.g., RAM, ROM, etc.) or send it to system 118. Efficiency-of-use module 206 can receive the battery status data and compute an efficiency-of-use score for the use of product 102 that takes at least this category of data into account. For example, the if user 300 uses product 102, e.g., a laptop and discharges the battery to 20% prior to charging it, a message including information such as an identifier for the user account for user; the type of data stored in the message; and the battery charge percentage can be generated and sent to system 118. In this example, efficiency-of-use module 206 can use the information that indicates that the battery was discharged down to 20% prior to it was recharged and compute an efficiency-of-use score that reflects how efficiently user 300 used the laptop.

Turning briefly back to FIG. 6D, operation 648 shows generating the efficiency-of-use score from at least information associated with processor utilization over the period of time that the physical product was used. For example, and again turning to FIG. 3 or 4, sensor module 312 associated with product 102 and/or sensor module 424 of device 302 or 308 can be an sensor module that measures how much of the CPU was used during the time period of interest, e.g., during the time period that product 102 is associated with the user account for user 300. Processor power consumption is closely connected with clock frequency and overclocking increases the system performance at the expense of energy efficiency. Moreover, central processing units that have multiple execution cores use more energy and different types of workloads can cause central processing units to use more energy. In this example, the CPU can execute a program that can store usage data and either record it (within memory, e.g., RAM, ROM, etc.) or cause it to be sent to system 118. Efficiency-of-use module 206 can receive the data and compute an efficiency-of-use score for the use of product 102 that takes at least this factor into account.

In a specific example, suppose user 300 logs into a computer system located at a library and starts watching a high-definition movie. In this example, suppose the playing of the movie causes the central processing unit to operate at near maximum capacity and in turn causes it to consume large amounts of energy of a long period of time. In this example, a program running on the computer system can record the CPU utilization information while user 300 is playing the movie and cause a message to be sent to system 118, which in this example could be a computer system within the library that maintains user accounts for people who visit and use the services of the library. Efficiency-of-use module 206 can receive the message and any other messages associated with the user account, and compute an efficiency-of-use score that at least takes CPU utilization into account.

Referring to operation 650, it shows generating the efficiency-of-use score from at least information associated with an amount of energy consumed over the period of time that user has control of the physical product. For example, and again turning to FIG. 3 or 4, sensor module 312 associated with product 102 and/or sensor module 424 of device 302 and/or 308 can be an sensor module that measures how much energy product 102 uses when, for example, it is associated with the user account for user 300, i.e., for a brief period of time, e.g., while user 300 rents or borrows product 102, or a longer period of time, e.g., the period of time that user owns product 102 or a portion thereof. In this example, the amount of energy product 102 uses can be used to determine how efficiently it is being used. For example, product 102 can be associated with an energy profile, which describes an efficient amount of energy for product 102 to use over a period of time, e.g., a minute, hour, day, week, etc. In this example, the amount of energy product 102 over the measuring period of time can be tracked and used to compute an efficiency-of-use score.

Suppose product 102 is a high definition plasma TV. In this example, suppose the TV includes a sensor module that measures how much energy is consumed by the TV. For example, the sensor module could be placed within the circuit that interfaces the TV with an electrical outlet. In this example, the sensor module can record how much energy the TV consumes and send the information to system 118, which could be maintained by the government, a “Green organization,” or the user, i.e., system 118 could be a home computer system. Suppose in this example that user 300 has left the TV on for that past two days while he or she was away from home. In this example, at the end of each day the sensor module could send how much energy it has consumed to system 118. Efficiency-of-use module 206 can receive the information and compare it to a use profile that includes information that indicates normal use of the TV. Efficiency-of-use module 206 can use the profile and the information from sensor to compute an efficiency-of-use score that reflects that the user has inefficiently used the TV by leaving it on for two full days.

Referring to operation 652 it shows generating the efficiency-of-use score from at least information associated with an estimated amount of work per unit of fuel achieved by the physical product. For example, and again turning to FIG. 3 or 4, sensor module 312 associated with product 102 and/or sensor module 424 of device 302 and/or 308 can be an sensor module that measures how much work per unit of fuel consumed product 102 has done when, for example, it is associated with the user account for user 300, i.e., for a brief period of time, e.g., while user 300 rents or borrows product 102, or a longer period of time, e.g., the time period that user 300 owns product 102 or a portion thereof. In this example, the amount of work done per unit of fuel, i.e., its fuel efficiency, can be used to determine how efficiently it is being used. For example, the fuel efficiency of product 102 could the amount of operating time a cellular phone achieves per charge of a battery, i.e., the fuel in this example would be the energy charge stored in the battery. In another example, the fuel efficiency of product 102 could be the number of miles driven per gallon of bio-diesel fuel.

Similar to the foregoing examples, product 102 can be associated with fuel efficiency profile, which describes an efficient amount of work achieved per unit of fuel. In this example, a sensor can be incorporated into product 102, e.g., a module of executable instructions running on a cellular phone can compute the total amount of time it has been in operation since its last charge, which can compute the fuel efficiency of product 102 and send the information to system 118, e.g., a computer system controlled by user, the cellular phone company, the electric company, etc., and used to compute an efficiency-of-use score.

Continuing with the description of FIG. 6D, operation 654 shows generating the efficiency-of-use score from at least sound information for the physical product generated by a microphone. For example, and again turning to FIG. 3 or 4, sensor module 312 associated with product 102 and/or sensor module 424 of device 302 and/or 308 can be an sensor module that includes a microphone and is configured to detect sounds made by internal components of product 102, e.g., motor bearings, fans, etc. In this example, the sounds made by internal components as they wear out can be used to compute an efficiency-of-use score. For example, as product 102 ages the components may wear and start to generate noises. This information can be captured by the microphone and sent to system 118 and used to generate an efficiency-of-use score. In a specific example, breaks of an automobile begin to squeak at the end of their service life. Continued use of product 102 with worn out components (such as breaks) is inefficient and potentially dangerous. In this exemplary embodiment, use of a product with worn out components can be used to affect an efficiency-of-use score.

Turning now to FIG. 6E, it illustrates additional operations that can be executed in conjunction with those depicted by FIG. 5 including operations 656-680. Referring to operation 656, it shows generating the efficiency-of-use score from at least information associated with an amount of light reflected by the physical product. Referring now to FIG. 3 and/or FIG. 4, sensor module 312 or 424 in can be a sensor module that measures light, e.g., infrared light, etc., reflected off product 102 or a sub-component of product 102. In this specific example, the sensor module can use the amount of light that is reflected off a component to determine how efficiently product 102 was used during the period of time that product 102 is controlled by user 300, i.e., during the time product 102 is associated with the user account for user 300. In this example, the sensor module can generate data and encode it within a message that could include a field that identifies product 102; the type of data stored in the message; and the data. This message can be sent to networking module 114 of system 118. The message can be routed to efficiency-of-use module 206, which can extract the data and use it to compute an efficiency-of-use score.

In a specific example, suppose product 102 is a blender located in product consumption location 108, which could be a communal kitchen area of an apartment building or dormitory. In this example, suppose the laser module is installed within the blender so that it can reflect a laser beam off the blades of the blender. In this example, the laser module can determine how much light reflects off the blades and store the information. After user 300 uses the blender, the laser module can again gather information that indicates how much light is reflecting off the blades and send the information that reflects how much light reflected off the blades before and after the user used the blender to system 118. The information can be routed to the efficiency-of-use module 206; and used to calculate an efficiency-of-use score. Alternatively, instead of sending the before and after laser information, the blender may transmit the laser information gathered after the use; compare it to a use profile stored in product profile database 208; calculate an efficiency-of-use score; and update the profile for the blender to reflect the current state of it.

Referring to operation 658E, it shows generating the efficiency-of-use score from at least information associated with an amount of bandwidth used by the physical product over the period of time that the user has control of the physical product. For example, and again referring to FIG. 3 and/or FIG. 4, sensor module 312 or 424 in can be a sensor module, e.g., a program running within a computing device such as a mobile phone, desktop computer system, etc., that records the amount of bandwidth used by product 102. For example, the amount of bandwidth, e.g., network bandwidth, used by product 102 can be tracked during a period of time that it is associated with a user account for user 300, i.e., a brief period of time, e.g., while user 300 rents or borrows product 102, or a longer period of time, e.g., the period of time that user owns product 102 or a portion thereof. In this example, the amount of bandwidth product 102 uses can be used to determine how efficiently it is being used. For example, product 102 can be associated with a profile, which describes an efficient amount of bandwidth for product 102 to use over a period of time, e.g., a minute, hour, day, week, etc. The profile can be set by the network provider, a group of friends, etc. In this example, the amount of bandwidth product 102 uses over the measuring period of time can be tracked and used to compute an efficiency-of-use score.

Continuing with the description of FIG. 6E, operation 660 shows generating the efficiency-of-use score from at least information associated with mileage driven over the period of time that the physical product was used. For example, and again referring to FIG. 3 and/or FIG. 4, suppose product 102 is a vehicle. In this example, a sensor module 312 or 424, which could be a GPS module, an odometer, etc., can record the amount of miles driven per trip. In this example, the mileage the vehicle was driven can be used to determine how efficiently it is being used or was used. For example, product 102 can be associated with a profile, which describes an efficient number miles driven per trip that is set by the owner of the vehicle, a group of friends, the government, etc. In this example, the amount of miles product 102 is driven can be tracked and used to compute an efficiency-of-use score. In a specific example, the profile could indicate that short trips of less than 3 miles are inefficient uses of automobiles. In this example, if a user were to drive his or her car down the block to run an errand he or she can be penalized for wasting resources by receiving a bad efficiency-of-use score.

Referring now to operation 662, it shows generating the efficiency-of-use score from at least information associated with an amount of physical damage to the physical product that occurred during the time period that the user has control of the physical product. Turning back to FIG. 3 and/or FIG. 4, sensor module 312 or 424 in can be a sensor module can be attached to product 102, a sub-component of product 102, and/or a device, e.g., device 302 and/or 308, that is configured to identify the amount of damage that was caused to product 102 while it was associated with the user account for user 300. For example, the sensor module could be an accelerometer, which could detect sudden decoration which could be indicative of impact. In another embodiment, the sensor module could include an onboard computing device such as a car-computer. In this example, the computer could detect deployment of air bags or if the anti-lock brakes were engaged. In yet another specific example, the information could be captured by an agent during a visual inspection of product 102. For example, the agent could input information that describes the damage done to vehicle into device 308. Any or all of the aforementioned information can be captured and encoded within a message that could include a field that identifies product 102; the type(s) of data stored in the message; and the data. This message can be sent, e.g., via an adaptor attached to product 102 or an adaptor attached to mobile device 302 or 308, to networking module 114 of system 118. The message can be routed to efficiency-of-use module 206, which can extract the data and use it to compute an efficiency-of-use score.

Turning to operation 664, it shows dissociating the user account with the physical product in response to a signal identifying that the user has given up control of the physical product. For example, and referring to FIG. 2, in an exemplary embodiment networking module 114 can receive one or more packets indicative of a message that indicates that user 300 has given up, i.e., relinquished physical or legal ownership or possession of product 102. Networking module 114 can route the message to association module 202, which can update a table of data that maps specific instances of products, i.e., specific products, to user accounts to indicate that product 102 is no longer being used by user 300. In a specific example, each user account can include product list 226 that lists the products that are currently controlled, i.e., owned, borrowed, rented, etc., by the user. In this specific example, association module 202 can access user account 250 and update product list 226 to reflect that product 102 is no longer controlled by user 300. For example, user 300 may have returned the rental product or sold a product he or she owned to another user or to product retailer location 106.

Referring to operation 666, it shows adjusting a cumulative-efficiency-of-use-score associated with the user account based at least on the efficiency-of-use score. For example, and referring again to FIG. 2, efficiency-of-use module 206 can compute an efficiency-of-use score for the use of product 102 (the score could be for a portion of the time that user 300 controls product 102 or for the entire time user 300 controls product 102) and use it to update a cumulative-efficiency-of-use score stored in ecological-impact table 230 for the user account for user 300. For example, the cumulative-efficiency-of-use score could be a score that captures how efficient user 300 uses a plurality of products, e.g., all the products he or she owns, rents, borrows, etc. In a specific example, the cumulative-efficiency-of-use score could be computed from efficiency-of-use scores associated with TVs, refrigerators, automobiles, cellular phones, clothing, shoes, etc. In this exemplary embodiment, each efficiency-of-use score can be weighted in order to combine it with other scores. In this way, the efficiency-of-use score for using an automobile can be combined with an efficiency-of-use score with a TV.

Turning to operation 668, it shows generating a webpage that includes information based at least in part on the efficiency-of-use-score. For example, and turning to FIG. 2, in an exemplary embodiment system 118 can include web-server module 236, which can be configured to generate a web-page that can include information that is at least based in part on the efficiency-of-use score for the use of product 102. For example, the web-page could include the efficiency-of-use score, a graph that includes the efficiency-of-use score, a graph that uses the efficiency-of-use score as a data point, a cumulative efficiency-of-use score, reward/penalties associated with user account 250, etc.

Continuing with the description of FIG. 6E, operation 670 shows converting the efficiency-of-use score to a monetary value. In an exemplary embodiment, and turning to FIG. 2, the efficiency-of-use score associated with the user of product 102 can be converted into an amount of money by conversion module 238. For example, conversion module 238 can store a conversion factor that can be used along with the efficiency-of-use score to compute an amount of money. In a specific example, the conversion factor can be based in part on the amount of wear-and-tear caused by user 300 and/or the amount of product 102 that was consumed by user 300 and the price of product 102 on a market.

Turning to operation 672, it shows charging the user account a fee based on the efficiency-of-use score. For example, and again referring to FIG. 2, in this embodiment system 118 can include accounting module 240, e.g., a module of executable instructions that can run on a central processing unit. In this example, accounting module 240 can be configured to charge user 300 a fee based on how he or she used product 102. For example, accounting module 240 could include a table of information that maps efficiency-of-use scores to fees, which can be set by, for example, the owner of product 102, the government, the utility company, a “Green Organization,” user 300, etc. In an exemplary embodiment, the fee can be based the efficiency-of-use score. For example, accounting module 240 can include a table of information that maps different efficiency-of-use scores to different fees. For example, if the score is a value such as 0-10, in an embodiment each integer could be charged a different fee. Thus, efficient uses of product 102 may not have an extra fee attached. In another exemplary embodiment, only inefficient uses over a certain threshold, e.g., 6 may be charged. In another exemplary embodiment, the fee could be based on whether or not an abstract efficiency-of-use score, i.e., a score such as “bad,” “good,” etc., is greater than a threshold, i.e., a fee may be charged in the instance that the score is computed to be “bad.”

In a specific example, suppose user 300 uses a car and then checks it in. A signal, which could optionally include efficiency data for a category information that identifies user account 250, product 102, etc., can be sent via network 100 to networking module 114. Networking module 114, e.g., an Ethernet adaptor and the firmware/software necessary to control it, can route the signal to efficiency-of-use module 206, which can compute an efficiency-of-use score. In this example, the efficiency-of-use score can be routed to accounting module 240, which can use the score to look of a fee. In this example, suppose the efficiency-of-use score is 89 (out of a possible score of 100) and in this example, suppose this score means that the use was 89% efficient. Accounting module 240 can run and compute a fee by, e.g., comparing the score to information in a table, or using the score in a computation and determine that user 300 should be charged $50. Accounting module 240 can then charge the fee to a balance associated with user account 250 for user 300. Alternatively, charging user 300 a fee can include causing a fee to be charged to a user account associated with user 300. For example, accounting module 240 can send a request to charge a fee to a credit card number associated with user 300.

Referring again to FIG. 6E, operation 674 shows associating a reward with the user account in response to a comparison between the efficiency-of-use score and a threshold. For example, in an exemplary embodiment, user 300 can be given a reward based on his or her efficiency-of-use score by associating information that defines a reward with his or her user account, e.g., user account 250. For example, and referring to FIG. 2, reward/penalty module 248 can be configured to receive a message from efficiency-of-use module 206 that includes an identifier for user account 250, an identifier for product 102, the efficiency-of-use score, etc. Reward/penalty module 248 can parse the message; lookup product 102; and compare the efficiency-of-use score to a threshold. In this example, reward/penalty module 248 can determine to grant user 300 a reward and store information indicative of a reward in reward/penalty user information table 228. In an exemplary embodiment, the reward could be a coupon, a trophy Icon that can be integrated into an email signature block, information that causes product 102 to indicate that it is being used efficiently (for example, product 102 may change color to indicate that it was used or is being used efficiently), information that causes a third party to grant enhanced level of service to user 300, e.g., cheaper monthly cable bill, etc., money, tickets to the movies, etc. Once the information is stored in user information table 228, user 300 may access it via a web-page that displays his or her user account. In some instances, user 300 may print off tickets or other printable rewards. In others, the association of a reward will cause system 118 to communicate with a third party to enhance a service associated with user, e.g., decreased cable bill.

In a specific example, suppose user 300 is using his or her laptop computer efficiently. For example, the laptop settings have been configured in such a way that causes the laptop to use less energy to operate, e.g., the monitor is dimmed, unused adaptors are disabled, etc. In this example, suppose the laptop includes efficiency-of-use module 324 and computes an efficiency-of-use score. In this example, suppose the laptop also includes reward/penalty module 330. In this example, the efficiency-of-use score can be routed to reward/penalty module 330, which can compare the score to a threshold. In this example, suppose that reward/penalty module 330 determines that the score is associated with a reward that allows user 300 to change the color of an indicator, e.g., an LCD screen, etc., to reflect that he is using the laptop efficiently. In this example, reward/penalty module 330 will determine that the score allows the LCD screen color to be changed and send a signal to it to cause the LCD screen to change its color.

Turing briefly back to FIG. 6E, operation 676 shows associating a penalty with the user account in response to a comparison between the efficiency-of-use score and a threshold. For example, in an exemplary embodiment user 300 can be given a reward based on his or her efficiency-of-use score. For example, and referring to FIG. 2, reward/penalty module 248 can be configured to receive a message from efficiency-of-use module 206 that includes an identifier for user account 250; an identifier for product 102; and the efficiency-of-use score. Reward/penalty module 248 can parse the message; lookup product 102; and compare the efficiency-of-use score to a threshold. In this example, reward/penalty module 248 can determine to penalize user 300 based on his or her efficiency-of-use score. For example, the score may be too high or in some way indicative of inefficient use. In response to this determination, reward/penalty module 248 can send a message to user account database 204 that includes information indicative of a penalty. User account database 204 can receive the message and add the penalty to reward/penalty user information table 228. In an exemplary embodiment, the penalty could be a negative status Icon, which is integrated into an email signature block, information that causes product 102 to indicate that it is being used inefficiently, information that causes a third party to reduce the level of service to user 300, e.g., more expensive cellular phone bill, etc., etc.

Turning now to operation 678 of FIG. 6, it shows sending the efficiency-of-use score to a monitoring organization. For example, in this exemplary embodiment, the efficiency-of-use score generated for user 300 can be sent to a monitoring organization that monitors efficiency-of-use scores. For example, the monitoring organization could be the government, a utility company; a “Green Organization,” the owner of product 102, a social networking website, etc. In this example, efficiency-of-use module 206 can generate a message that includes the efficiency-of-use score; an identifier for product 102; and an identifier for the user account for user 300 and route it to the monitoring organization. In the instance that system 118 is integrated within the monitoring organization, the message could be routed to web-server module 236 or an administrator's computer system, e.g., in an email, or an internal web-page, etc. In the instance that the monitoring organization is a third party, e.g., the government, the message can be routed to networking module 114, which can send one or more packets of information via network 114, e.g., the Internet, to a computer system associated with the monitoring organization. For example, the message could be routed to a database server associated with the utility company or government. Alternatively, the message could be communicated to the monitoring organization via text message, email, automated voice message, etc.

Referring to operation 680, it shows causing the efficiency-of-use score to be published. For example, in this embodiment, the efficiency-of-use score could be published, which could shame or honor user 300, depending on the score. For example, efficiency-of-use module 206 can generate a message that includes the efficiency-of-use score, a user account and a product identifier and route the message to web-server module 236, which can in turn cause the efficiency-of-use score to be published by causing it to be displayed by a web-page.

In another specific example, and referring to FIG. 1, media distribution center 116, which could be maintained by a third party (the government, a utility provider, etc.), can disseminate information that is at least based in part on the efficiency-of-use score. In this example, system 118 could cause the efficiency-of-use score to be published by sending a signal to media distribution center 116, e.g., one or more packets of information. The signal could be received by a computer system at media distribution center 116 and media distribution center 116 could then publish the score. Media distribution center 116 could be an organization that allows users to create Internet-based journals, e.g., blogs. In this example, the blog could receive the ecological-impact score from, for example, device system 118 via network 100. The efficiency-of-use score could then be stored within a webpage or document that is accessible via the blog. In another specific example, media distribution center 116 could have a short message service server that can broadcast the efficiency-of-use score to users in a text message. In another specific example, media distribution center 116 could include an email server that is configured to generate emails that include the efficiency-of-use score and send them to users. In yet another specific example, media distribution center 116 could disseminate the efficiency-of-use score over a radio signal, e.g., a radio station, via a news letter, and/or via television.

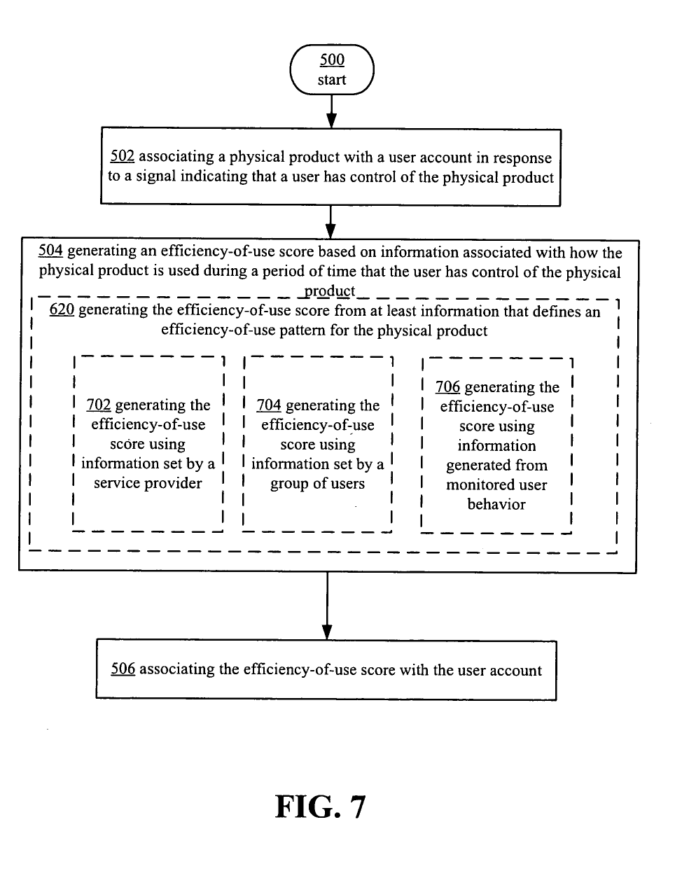

Turning now to FIG. 7, it illustrates an alternative embodiment of the operational procedure illustrated by FIG. 6B including operations 702-706. Turing to operation 702, it illustrates generating the efficiency-of-use score using information set by a service provider. For example, information set by service provider 112 to compute the efficiency-of-use score. For example, service provider 112, which could be an entity that controls system 118 such as a rental car company, a rent-to-own company, a neighborhood association, a product owner, etc., can set information, e.g., weights, variables, use-profiles for one or more categories, etc. to affect how efficiency-of-use module 206 computes efficiency-of-use scores. Thus, what it means to use product 102 efficiently could be defined by a service provider 112. For example, the information could be used to change the weights used for different sub-scores when efficiency-of-use module 206 computes them. In another example, the information could be a use-profiles for categories of data. For example, product 102 could be a rental product 102 such as a car, a piece of heavy machinery, a TV, etc. In this example, service provider 112 could create an efficiency-of-use profile that takes the interests of the owner into account. Service provider 112 could emphasize certain categories of data over others based on the organization's interest in product 102. For example, in the instance that product 102 is a rental car, service provider 112, e.g., the rental car company, could deemphasized a use profile associated with average miles per gallon of gasoline by using a use profile that defines efficient use more leniently.

Continuing with the description of FIG. 7, operation 704 shows generating the efficiency-of-use score using information set by a group of users. For example, information set by a group of users can be used to compute the efficiency-of-use score. For example, a group of users such as a “Green group” can organize itself and create its own use profiles for products. In this example, the users may hold themselves to different standard than a company or the government by setting information, e.g., weights, variables, use-profiles for one or more categories, etc. to affect how efficiency-of-use module 206 computes efficiency-of-use scores to compute scores based on how the use of products directly affect the environment. Here, the users may create a group and add information to product profile database 208 and/or a table of variables and weights that efficiency-of-use module 206 uses when computing scores. When efficiency-of-use module 206 computes scores for the members of the group, it can use the identifier for the user's account to locate the information instead of, or in addition to, the standard information, e.g., variables, weights, and/or use profiles. In this regard, user 300 may receive a plurality of efficiency-of-use scores for his or her use of product 102: a standard score, a score calculated using the user defined use profiles, a score calculated from use profiles set by a service provider, etc.

Continuing with the description of FIG. 7, operation 706 shows generating the efficiency-of-use score from at least information defining an efficiency-of-use pattern generated from monitored user behavior. In another exemplary embodiment, use patterns can be used to generate a relative score for a user's use of product 102 based on how other user's have used product 102 or a similar product, e.g., another instance of product 102. In this example, efficiency data can be generated for uses of product 102 or a similar product and a use profile can be created over time. In this example, when efficiency-of-use module 206 computes an efficiency-of-use score, user 300 will be judged based on how his or her peers have used the same or a similar product.

In a specific example, suppose product 102 is an automobile and the use profile is generated over time for miles per gallon of gasoline. In this example, suppose that the automobile, when running efficiently, obtains 33 miles per gallon of gasoline on the highway; however, the average users that operate the vehicle and vehicles of the same make and model obtain 27 miles per gallon. In this example, efficiency-of-use module 206 can be configured to calculate efficiency-of-use scores that use the use profile that reflects that users obtain 27 miles per gallon. Similar to that described above, efficiency-of-use module 206 could compute multiple efficiency-of-use scores for the same use: one based on how he or she compares to other users, one that is based on how he or she compares to an optimal use of product 102, etc.

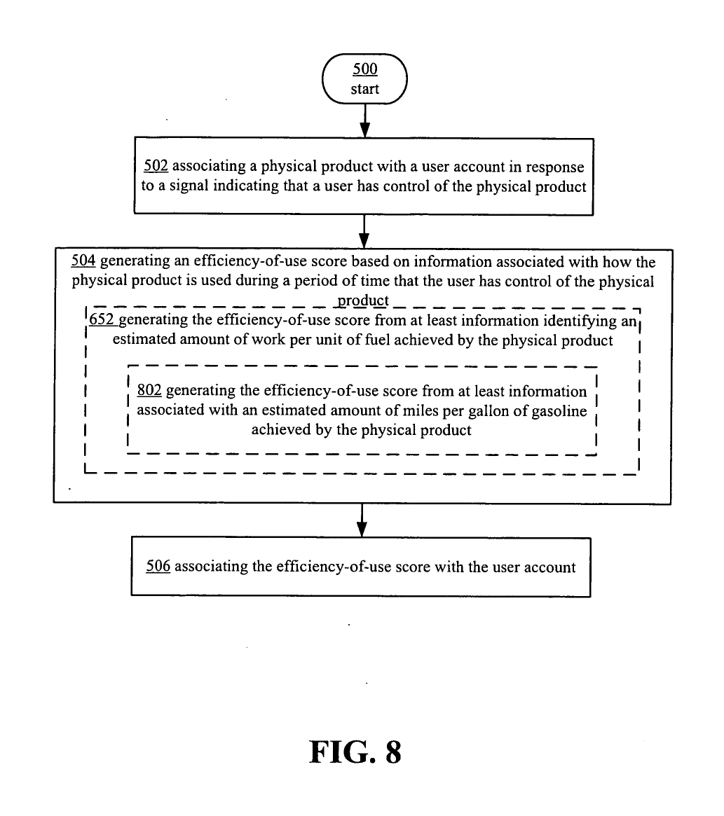

Referring now to FIG. 8, it illustrates an alternative embodiment of the operational procedure illustrated by FIG. 6D including operation 802, which shows generating the efficiency-of-use score from at least information associated with an estimated amount of miles per gallon of gasoline achieved by the physical product. For example, and turning to FIG. 3, in an exemplary embodiment product 102 can be a vehicle that operates on gasoline such as a car, a boat, a plane, etc. In this example, sensor module 312, which could be an odometer, can estimate the miles per gallon of gasoline that the vehicle achieved during the time period that it was controlled by user 300. For example, the time period could cover the time it took user 300 to use the vehicle to drive downtown to pick his or her spouse up from work and drive home. Upon arrival at home, the miles per gallon of gasoline data can be sent in a message to system 118. For example, the vehicle itself could sent the data or an external device can, e.g., device 302. Efficiency-of-use module 206 of FIG. 2 can receive the message; extract the data; and compute an efficiency-of-use score for the trip that takes into account the miles per gallon of gas achieved for the trip.

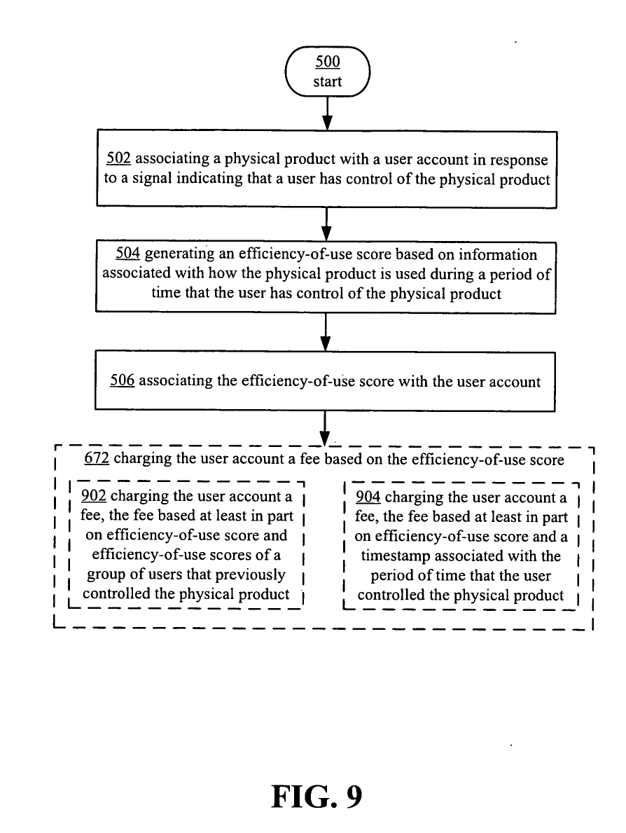

Turning now to FIG. 9, it illustrates an alternative embodiment of the operational procedure depicted by FIG. 6E that includes that additional operations 902 and 904. Operation 902 illustrates charging the user account a fee based at least in part on the efficiency-of-use score and efficiency-of-use scores of a group of users that previously controlled the physical product. Again referring to FIG. 2, accounting module 240 can be configured to compute a fee that is a relative fee, i.e., a fee that is based on the scores of those who used product 102 before user 300. For example, score history database 242 can store an efficiency-of-use score history for each product, such as product 102. For example, each time efficiency-of-use module 206 generates an efficiency-of-use score for product 102, a message can be generated that includes an identifier for product 102 and the efficiency-of-use score. The message can be sent to score history database 242, which can include logic for parsing the message and updating a history for product 102. In this exemplary configuration, when an efficiency-of-use score is computed it can be sent via a message to accounting module 240. Accounting module 240 can receive the message and access score history database 242 in order to compute a fee that is based on prior use of product 102. For example, the fee could be based on a threshold. In this configuration, if the score associated with user 300 is greater than the average, mean, etc., score of two or more prior users a fee can be charged. In another example, the fee can be based on the difference between the score for user 300 and the average, mean, etc., score of two or more prior users.

Continuing with the description of FIG. 9, operation 904 shows charging the user account a fee, the fee based at least in part on the efficiency-of-use score and a timestamp associated with the period of time that the user controlled the physical product. For example, in this embodiment, accounting module 240 can compute a fee that is based on the efficiency-of-use score and time that product 102 was used. In this example, the use of product 102 during certain times of the day can be more expensive than others. For example, use of a rental car during the weekend or around a holiday can cost more than use during the weekday or regular work week. Similarly, a user may be charged more to use product 102 during busy times of the day or when there is a high demand for product 102. In this example, accounting module 240 can include different tables of information that can be used at different times of the day to compute efficiency-of-use scores.

In a specific example, suppose product 102 is communal disk washing machine. In this example, suppose user 300 uses the dish washing machine during a period of time with associated with a high demand, i.e., many users want to use it at this time of day, and/or high demand for water, e.g., during the hottest time of the day, which may be between 5:00 pm and 11:00 pm on hot summer days. In this example, accounting module 240 could include a fee table for the hours between 5:00 pm and 11:00 pm and one or more other tables for different portions of the day. When user 300 uses the dish washing machine during a time of peak demand, e.g., at 7 pm, accounting module 240 can be configured to charge user 300 a fee that is based on how efficiently the user used the dish washing machine and the fee table for the hours of 5:00 pm and 11:00 pm.

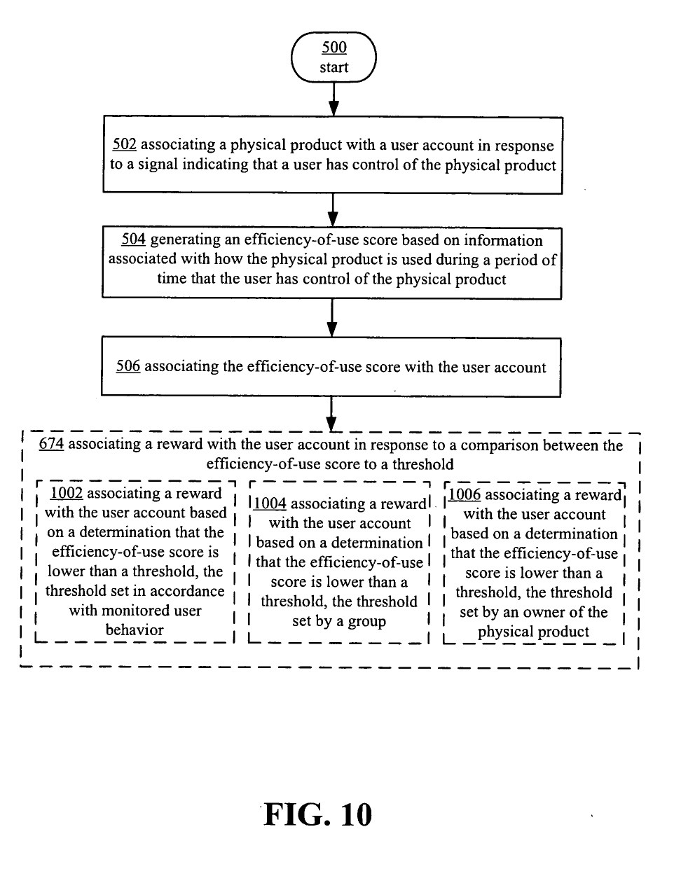

Turning to FIG. 10, it illustrates an alternative embodiment of the operational procedure illustrated by FIG. 6E including operations 1002, 1004, 1006. Turning to the figure, in this exemplary embodiment the operation associating a reward with the user account in response to a comparison between the efficiency-of-use score and a threshold can include operation 1002, which shows associating a reward with the user account based on a determination that the efficiency-of-use score is lower than a threshold, the threshold set in accordance with monitored user behavior. For example, and referring to FIG. 2, in an embodiment reward/penalty module 248 can include a table of information that maps rewards to efficiency-of-use scores. In this example, the efficiency-of-use scores can be set based on the efficiency-of-use scores of users that use product 102 or a similar product. In this example, a reward/penalty module 248 can be configured to grant rewards in the instance that their efficiency-of-use scores are lower than, for example, the average, mean, etc., efficiency-of-use score calculated for users. For example, score history database 242 can be configured to store a history of scores generated from the use of product 102 and use scores generated from the use of similar products to generate an average efficiency-of-use score. The average efficiency-of-use score can then be stored in reward/penalty module 248 and used to determine whether or not to grant a reward to user 300.

Continuing with the description of FIG. 10, operation 1004 shows associating a reward with the user account based on a determination that the efficiency-of-use score is lower than a threshold, the threshold set by a group. For example, and again referring to FIG. 2, in this example users can form a group and set an efficiency-of-use score that can be used to grant a reward, e.g., a reward offered by the group. In a specific example, a “Green Organization” can offer rewards to want to use their products as efficiently as possible. In this example, reward/penalty module 248 can store a table that maps efficiency-of-use scores to rewards offered by the “Green Organization.” When a user uses a product that is associated with a reward from the “Green Organization,” reward/penalty module 248 can compare the score to the threshold stored in the table and determine whether or not to grant the reward.

Turning now to operation 1006, it shows associating a reward with the user account based on a determination that the efficiency-of-use score is lower than a threshold, the threshold set by an owner of the physical product. For example, and again referring to FIG. 2, in this example an owner can set an efficiency-of-use score threshold for use with his or her product to determine whether to grant a reward. In this example, reward/penalty module 248 can store a table that maps efficiency-of-use scores to rewards offered by, for example, the owner. When a user uses a product that is associated with a reward from the owner, efficiency-of-use module 206 can send a message that includes an identifier that uniquely identifies product 102; an identifier for the user account; and the score to reward/penalty module 248. Reward/penalty module 248 can use the unique identifier for product 102 to obtain the table and compare the score to the threshold stored in the table to determine whether or not to grant the reward.

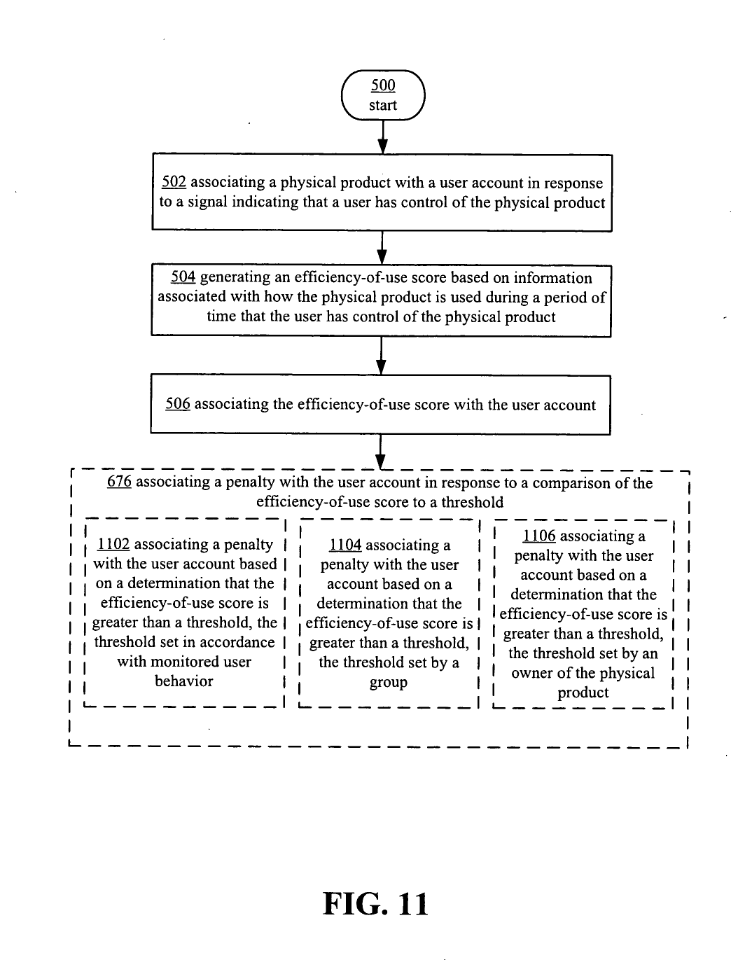

Turning now to FIG. 11, it illustrates an alternative embodiment of the operational procedure illustrated by FIG. 6E including the additional operations 1102-1106. Turning to operation 1102, it shows associating a penalty with the user account based on a determination that the efficiency-of-use score is greater than a threshold, the threshold set in accordance with monitored user behavior. For example, and referring to FIG. 2, in an embodiment reward/penalty module 248 can include a table of information that maps rewards to efficiency-of-use scores. In this example, the efficiency-of-use scores can be set based on the efficiency-of-use scores of users that use product 102 or a similar product. In this example, a reward/penalty module 248 can be configured to grant rewards in the instance that their efficiency-of-use scores are lower than, for example, the average, mean, etc., efficiency-of-use score calculated for users. For example, score history database 242 can be configured to store a history of scores generated from the use of product 102 and use scores generated from the use of similar products to generate mean efficiency-of-use score. The mean efficiency-of-use score can then be stored in reward/penalty module 248 and used to determine whether or not to grant a reward to user 300.

Continuing with the description of FIG. 11, operation 1104 shows associating a penalty with the user account based on a determination that the efficiency-of-use score is greater than a threshold, the threshold set by a group. For example, and again referring to FIG. 2, in this example users can form a group and set an efficiency-of-use score that can be used to penalize members of the group that fall below a standard. In a specific example, the government can penalize users that use their products in a way that has been deemed to be inefficient in an attempt to force users to use products as efficiently as possible. In this example, reward/penalty module 248 can store a table that maps efficiency-of-use scores to penalties.

Turning now to operation 1106, it shows associating a penalty with the user account based on a determination that the efficiency-of-use score is greater than a threshold, the threshold set by an owner of the physical product. For example, and again referring to FIG. 2, in this example an owner can set an efficiency-of-use score threshold for use with his or her product to determine whether to penalize the user for his inefficient use of product 102. In this example, reward/penalty module 248 can store a table that maps efficiency-of-use scores to penalties, e.g., lose of use, extra fees, etc., set by, for example, the owner. When a user uses a product that is associated with a penalty set by the owner, efficiency-of-use module 206 can send a message that includes an identifier that uniquely identifies product 102; an identifier for the user account; and the score to reward/penalty module 248. Reward/penalty module 248 can use the unique identifier for product 102 to obtain the table and compare the score to the threshold stored in the table to determine whether or not to penalize user 300.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. A computer implemented method, comprising:
associating a physical product with a user account in response to a signal indicating that a user has control of the physical product;
generating an efficiency-of-use score based on information associated with how the physical product is used during a period of time that the user has control of the physical product; and
associating the efficiency-of-use score with the user account.

2. The computer implemented method of claim 1, wherein associating a physical product with a user account in response to a signal indicating that a user has control of the physical product further comprises:
associating the physical product with the user account in response to receiving a device-readable indicator associated with the physical product.

3. The computer implemented method of claim 1, further comprising:
receiving the information associated with how the physical product was used from the physical product.

4. The computer implemented method of claim 1, further comprising:
receiving the information associated with how the physical product was used from a device.

5. The computer implemented method of claim 1, further comprising:
sending the efficiency-of-use score to a device associated with the user account.

6. The computer implemented method of claim 1, further comprising:
sending the efficiency-of-use score to the physical product.

7. The computer implemented method of claim 1, wherein generating an efficiency-of-use score based on information associated with how the physical product is used during a period of time that the user has control of the physical product further comprises:
generating the efficiency-of-use score from at least information that defines an efficiency-of-use pattern for the physical product.

8. The computer implemented method of claim 7, wherein generating the efficiency-of-use score from at least information that defines an efficiency-of-use pattern for the physical product further comprises:
generating the efficiency-of-use score using information set by a service provider.

9. The computer implemented method of claim 7, wherein generating the efficiency-of-use score from at least information that defines an efficiency-of-use pattern for the physical product further comprises:
generating the efficiency-of-use score using information set by a group of users.

10. The computer implemented method of claim 7, wherein generating the efficiency-of-use score from at least information that defines an efficiency-of-use pattern for the physical product further comprises:
generating the efficiency-of-use score from at least information defining an efficiency-of-use pattern generated from monitored user behavior.

11. The computer implemented method of claim 1, wherein generating an efficiency-of-use score based on information associated with how the physical product is used during a period of time that the user has control of the physical product further comprises:
generating, at predetermined time intervals, an efficiency-of-use score from at least information associated with how the physical product is being used.

12. The computer implemented method of claim 1, further comprising:
sending a signal to the physical product and/or a device associated with the user account in response to a determination that the physical product is being used efficiently or inefficiently.

13. The computer implemented method of claim 1, wherein generating an efficiency-of-use score based on information associated with how the physical product is used during a period of time that the user has control of the physical product, further comprises:
generating the efficiency-of-use score from at least temperature data generated by a temperature monitoring sensor.

14. The computer implemented method of claim 1, wherein generating an efficiency-of-use score based on information associated with how the physical product is used during a period of time that the user has control of the physical product further comprises:
generating the efficiency-of-use score from at least pressure data generated by a pressure monitoring sensor.

15. The computer implemented method of claim 1, wherein generating an efficiency-of-use score based on information associated with how the physical product is used during a period of time that the user has control of the physical product further comprises:
generating the efficiency-of-use score from at least information obtained from at least one image.

16. The computer implemented method of claim 1, wherein generating an efficiency-of-use score based on information associated with how the physical product is used during a period of time that the user has control of the physical product further comprises:
generating the efficiency-of-use score from at least information obtained by a laser.

17. The computer implemented method of claim 1, wherein generating an efficiency-of-use score based on information associated with how the physical product is used during a period of time that the user has control of the physical product further comprises:
generating the efficiency-of-use score from at least vibration information generated from a vibration monitoring sensor.

18. The computer implemented method of claim 1, wherein generating an efficiency-of-use score based on information associated with how the physical product is used during a period of time that the user has control of the physical product further comprises:
generating the efficiency-of-use score from at least impact data generated by an impact sensor.

19. The computer implemented method of claim 1, wherein generating an efficiency-of-use score based on information associated with how the physical product is used during a period of time that the user has control of the physical product further comprises:
generating the efficiency-of-use score from at least corrosion data generated by a corrosion sensor.

20. The computer implemented method of claim 1, wherein generating an efficiency-of-use score based on information associated with how the physical product is used during a period of time that the user has control of the physical product further comprises:
generating the efficiency-of-use score from at least an output of a sensor configured to measure concentrations of metallic elements in a lubricant.

21. The computer implemented method of claim 1, wherein generating an efficiency-of-use score based on information associated with how the physical product is used during a period of time that the user has control of the physical product further comprises:
generating the efficiency-of-use score from information obtained by a diagnostic computing device associated with the physical product.

22. The computer implemented method of claim 1, wherein generating an efficiency-of-use score based on information associated with how the physical product is used during a period of time that the user has control of the physical product further comprises:
generating the efficiency-of-use score from at least revolutions per minute data generated by a tachometer.

23. The computer implemented method of claim 1, wherein generating an efficiency-of-use score based on information associated with how the physical product is used during a period of time that the user has control of the physical product further comprises:
generating the efficiency-of-use score from at least status information associated with a battery.

24. The computer implemented method of claim 1, wherein generating an efficiency-of-use score based on information associated with how the physical product is used during a period of time that the user has control of the physical product further comprises:
generating the efficiency-of-use score from at least information associated with processor utilization over the period of time that the physical product was used.

25. The computer implemented method of claim 1, wherein generating an efficiency-of-use score based on information associated with how the physical product is used during a period of time that the user has control of the physical product further comprises:
generating the efficiency-of-use score from at least information associated with an amount of energy consumed over the period of time that user has control of the physical product.

26. The computer implemented method of claim 1, wherein generating an efficiency-of-use score based on information associated with how the physical product is used during a period of time that the user has control of the physical product further comprises:
generating the efficiency-of-use score from at least information associated with an estimated amount of work per unit of fuel achieved by the physical product.

27. (canceled)

28. The computer implemented method of claim 1, wherein generating an efficiency-of-use score based on information associated with how the physical product is used during a period of time that the user has control of the physical product further comprises:
generating the efficiency-of-use score from at least sound information for the physical product generated by a microphone.

29. The computer implemented method of claim 1, wherein generating an efficiency-of-use score based on information associated with how the physical product is used during a period of time that the user has control of the physical product further comprises:
generating the efficiency-of-use score from at least information associated with an amount of light reflected by the physical product.

30. The computer implemented method of claim 1, wherein generating an efficiency-of-use score based on information associated with how the physical product is used during a period of time that the user has control of the physical product further comprises:
generating the efficiency-of-use score from at least information associated with an amount of bandwidth used by the physical product over the period of time that the user has control of the physical product.

31. The computer implemented method of claim 1, wherein generating an efficiency-of-use score based on information associated with how the physical product is used during a period of time that the user has control of the physical product further comprises:
generating the efficiency-of-use score from at least information associated with mileage driven over the period of time that the physical product was used.

32. The computer implemented method of claim 1, wherein generating an efficiency-of-use score based on information associated with how the physical product is used during a period of time that the user has control of the physical product further comprises:
generating the efficiency-of-use score from at least information associated with an amount of physical damage to the physical product that occurred during the time period that the user has control of the physical product.

33. The computer implemented method of claim 1, further comprising:
dissociating the user account with the physical product in response to a signal identifying that the user has given up control of the physical product.

34. The computer implemented method of claim 1 that includes generating an efficiency-of-use score based on information associated with how the physical product is used during a period of time that the user has control of the physical product, further comprising:
adjusting a cumulative-efficiency-of-use-score associated with the user account based at least on the efficiency-of-use score.

35. The computer implemented method of claim 1 that includes generating an efficiency-of-use score based on information associated with how the physical product is used during a period of time that the user has control of the physical product, further comprising:
generating a webpage that includes information based at least in part on the efficiency-of-use-score.

36. The computer implemented method of claim 1 that includes generating an efficiency-of-use score based on information associated with how the physical product is used during a period of time that the user has control of the physical product, further comprising:
converting the efficiency-of-use score to a monetary value.

37. The computer implemented method of claim 1 that includes generating an efficiency-of-use score based on information associated with how the physical product is used during a period of time that the user has control of the physical product, further comprising:
charging the user account a fee based on the efficiency-of-use score.

38-39. (canceled)

40. The computer implemented method of claim 1 that includes generating an efficiency-of-use score based on information associated with how the physical product is used during a period of time that the user has control of the physical product, further comprising:
associating a reward with the user account in response to a comparison between the efficiency-of-use score and a threshold.

41-43. (canceled)

44. The computer implemented method of claim 1, wherein associating a penalty with the user account in response to a comparison between the efficiency-of-use score and a threshold, further comprises:
associating a penalty with the user account in response to a comparison between the efficiency-of-use score and a threshold.

45-47. (canceled)

48. The computer implemented method of claim 1 that includes generating an efficiency-of-use score based on information associated with how the physical product is used during a period of time that the user has control of the physical product, further comprising:
sending the efficiency-of-use score to a monitoring organization.

49. The computer implemented method of claim 1 that includes generating an efficiency-of-use score based on information associated with how the physical product is used during a period of time that the user has control of the physical product, further comprising:
causing the efficiency-of-use score to be published.

50. A computer-readable storage medium, comprising:
instructions for associating a physical product with a user account in response to a signal indicating that a user has control of the physical product;
instructions for generating an efficiency-of-use score based on information associated with how the physical product is used during a period of time that the user has control of the physical product; and
instructions for associating the efficiency-of-use score with the user account.

51-98. (canceled)

99. A computer system, comprising:
circuitry for associating a physical product with a user account in response to a signal indicating that a user has control of the physical product;
circuitry for generating an efficiency-of-use score based on information associated with how the physical product is used during a period of time that the user has control of the physical product; and
circuitry for associating the efficiency-of-use score with the user account.

100-147. (canceled)
